(19) United States
(12) Patent Application Publication
(10) Pub. No.: US 2026/0178527 A1
(43) Pub. Date: Jun. 25, 2026

(54) PORT MAPPING FOR AGGREGATOR-DISAGGREGATOR

(71) Applicants: Jerome Jean RIBO, Lisle, IL (US); Anand Mohan PAPPU, Lisle, IL (US); Patrick Antoine RADA, Lisle, IL (US); Narasimha NOOKALA, Lisle, IL (US); Molex, LLC, Lisle, IL (US)

(72) Inventors: Alan T. Ruberg, Menlo Park, CA (US); Jerome Jean Ribo, San Jose, CA (US); Anand Mohan Pappu, Bangalore (IN); Patrick Antoine Rada, San Jose, CA (US); Narasimha Nookala, Saratoga, CA (US)

(21) Appl. No.: 19/132,389

(22) PCT Filed: Nov. 27, 2023
(86) PCT No.: PCT/US2023/081155

§ 371 Date: May 23, 2025

(30) Foreign Application Priority Data
Nov. 24, 2022 (IN) 202241067627
Dec. 14, 2022 (IN) 202241072099

(51) Int. Cl. G06F 13/40

(52) U.S. Cl. CPC G06F 13/4022

(57) ABSTRACT

Embodiments discussed herein refer to circuits for enabling a port mapping scheme among a pair of aggregator-disaggregator modules. The port mapping scheme may be implemented by a port mapping coordinator that configures a switch matrix. The switch matrix can connect any input signal to any output signal.

### RELATED APPLICATION

This patent application claims the benefit of Indian Provisional Patent Application No. 202241067627, filed Nov. 24, 2022, and Indian Provisional Patent Application No. 202241072099, filed Dec. 14, 2022, both of which are incorporated by reference in their entirety.

### BACKGROUND

Electronic devices can include multiple printed circuit boards to house various integrated circuits, connectors, and other components. When two or more boards are used, an interposer is typically used to connect one board to another board. The interposer uses a combination of vias and pins that interface with each other when the boards are connected. The quantity of interposer pins and vias can be substantial (e.g., hundreds or more pins and vias), and as a result, can occupy substantial real estate on the printed circuit boards. In addition, many electronic devices may execute communications according to many different protocol connections. Each of these protocols requires dedicated interposer connections, potentially resulting in too many wires, protocols, mechanical connectors, signal integrity problems (e.g., electrostatic discharge, electromagnetic interference, cross-talk, radio-frequency interference, etc.), physical links (PHYs), and/or power consumption. Thus, as more protocols are supported, additional hardware and software components are needed, thereby raising costs and real estate requirements.

### BRIEF DESCRIPTION OF THE DRAWINGS

FIG. 1 shows two legacy circuit boards designed for a board-to-board connection via a conventional interposer connection.

FIGS. 2A-2C show different illustrative circuit boards configured for a board-to-board connection using VPIO circuitry according to embodiments discussed herein.

FIG. 3A shows two illustrative circuits board configured for a board-to-board connection using interposer pins/vias, connectors, and VPIO circuitry according to embodiments discussed herein.

FIG. 3B shows an alternative to circuitry shown in FIG. 3A according to embodiments discussed herein.

FIG. 4 shows a system or device including printed circuit boards that have components and circuitry that communicate with each other, in accordance with some embodiments.

FIG. 5 shows another system or device including printed circuit boards that have components and circuitry that communicate with each other, in accordance with some embodiments.

FIG. 6A shows an illustrative VPIO circuitry in accordance with an embodiment.

FIG. 6B shows an illustrative low power exit and low power entry circuitry in accordance with an embodiment.

FIG. 7A shows an illustrative circuit schematic of port activity detection circuitry according to an embodiment.

FIG. 7B shows an illustrative timing diagram showing operation of port activity detection circuitry of FIG. 7A according to an embodiment.

FIG. 8A shows alternative port activity detection circuitry according to an embodiment.

FIG. 8B shows an illustrative timing diagram showing operation of port activity detection circuitry of FIG. 8A according to an embodiment.

FIG. 9 shows an illustrative bidirectional port activity detection circuitry according to an embodiment.

FIG. 10 shows illustrative port activity detection circuitry according to an embodiment.

FIG. 11 shows illustrative port activity detection circuitry according to an embodiment.

FIG. 12 shows illustrative port activity detection circuitry according to an embodiment.

FIG. 13 shows illustrative low power mode detection circuitry according to an embodiment.

FIG. 14A shows an illustrative process according to an embodiment.

FIG. 14B shows additional steps that may be taken as part a step in FIG. 14A according to an embodiment.

FIG. 15A shows an illustrative process according to an embodiment.

FIG. 15B shows additional steps that may be taken as part a step in FIG. 15A according to an embodiment.

FIG. 16 shows an illustrative process for exiting out of lower power mode and entering the low power mode according to an embodiment.

FIG. 17 shows an illustrative process for determining when to enter low power mode according to an embodiment.

FIG. 18 shows an illustrative switch matrix that can map any signal received on a source port to any destination port according to an embodiment.

FIGS. 19A and 19B contrast trace routing of a pair of VPIO ICs without and with use of pin mapping

FIG. 20 shows illustrative port mapping circuit for implementing a port mapping scheme according to an embodiment.

FIG. 21 shows illustrative port mapping circuit for implementing a port mapping scheme according to an embodiment.

FIG. 22 shows illustrative port mapping circuit for implementing a port mapping scheme according to an embodiment.

FIG. 23A shows illustrative port mapping circuit for implementing a port mapping scheme according to an embodiment.

FIG. 23B shows illustrative encoded message output by the port mapping circuit of FIG. 23A according to an embodiment.

FIG. 24 shows an illustrative example of two VPIO ICs that use port swapping to connect traces for a high speed communications link according to an embodiment.

FIG. 25 shows an illustrative example of two VPIO ICs that use groups of port mapping according to an embodiment.

FIG. 26 shows illustrative process according to an embodiment.

FIG. 27 shows illustrative port recovery circuitry according to an embodiment.

### DETAILED DESCRIPTION

Illustrative embodiments are now described more fully hereinafter with reference to the accompanying drawings, in which representative examples are shown. Indeed, the disclosed communication system and method may be embodied in many different forms and should not be construed as limited to the embodiments set forth herein. Like numbers refer to like elements throughout.

In the following detailed description, for purposes of explanation, numerous specific details are set forth to provide a thorough understanding of the various embodiments. Those of ordinary skill in the art will realize that these various embodiments are illustrative only and are not intended to be limiting in any way. Other embodiments will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

Embodiments discussed herein refer to systems, methods, and circuits for a virtual pipe input/output (VPIO or virtual pipe I/O) IC, circuitry, circuit, function block, system, or module that includes one or more virtual pipe engine (VPE) circuits that facilitate data transfer for multiple communication ports (also referred to as “ports”) between two or more printed circuit boards, while adhering to stringent maximum power consumption requirements. The VPIO circuitry can function as an extremely low power aggregator-disaggregator that has a high level of configurability for ease of deployment and layout routing in printed circuit boards. The aggregator-disaggregator can function by aggregating any number of signals or protocols supplied on any number of input ports into a fewer number of wires than input ports or to just one wire, pass the aggregated data through a medium, disaggregate the aggregated data, and recreate a copy of the original signals or protocols for conveyance to output ports. The medium represents a connection (e.g., a wired connection or a wireless connection) between the aggregator and the disaggregator, where the aggregator resides on a first circuit board and the disaggregator resides on a second circuit board. The aggregation and disaggregation are performed with extremely low latency and extremely low power consumption. The high level of configurability is realized by electronically remapping any of the signals or protocols on the input ports to any of the output ports. That is, the input ports may have specific locations and trace routings that are optimized for the circuit board to which they are affixed, yet the output ports may have completely different locations and trace routings that best suit the circuit board to which the output ports are affixed. The remapping enables both the aggregator side (e.g., input ports) and the disaggregator side (e.g., output ports) to maintain their optimal positioning and trace routing because any signals or protocols can be remapped port-per-port or group of ports-per-group of ports. This maximizes configurability and flexibility in terms of relative positions of ports or group of ports in the disaggregator versus the aggregator.

The VPIO circuitry can substantially reduce the number of ports of one or several connectors or interposers between one PCB to another, one box to another, etc. In addition, the VPIO circuitry provides configurability and flexibility with port mapping and group of ports mapping. The VPIO circuitry can effectively replace standard interposer or standard connector type connections that exist within a device or system by being able to selectively route input ports to output ports with minimal power penalty. An interposer or standard connector type is typically associated with having zero (or near zero) power penalty because the connections are direct port-to-port wired connections. In contrast, the VPIO circuitry eliminates the need for each port-to-port wired connection used by an interposer or wired connector, but requires power to operate the aggregator-disaggregator in connection with a port mapping scheme. The power required to operate the VPIO circuitry is extremely low and is designed to have a low or negligible impact on a power budget of the system in which the VPIO circuitry is used. For example, in one embodiment, the average power consumption by a pair of VPIO circuits is less than 10 mW. A typical range for the average power consumption depends on the signal speed applied to the ports, the number of low, medium and high-speed signals/ports and the activity level on each signal/port and may very well range from 1 uW to 100 mW.

Such low power consumption can be achieved by implementing a clock-less design that eliminates continuous power consumption cycles in favor of a sleep centric repetitive cycle alternating between sleep and active modes. As defined herein, the clock-less design can refer to using certain circuitry to exit out of a low power mode without requiring a clock signal that is sourced from a clock source such as an oscillator. That is, the VPIO circuitry remains in a sleep mode while there is no activity and transitions to the active mode on demand in response to an activity event (e.g., a data transition is provided on one of the input ports). When in the active mode, data is rapidly transmitted from the aggregator to the disaggregator and then the VPIO circuitry rapidly transitions back to sleep mode. The VPIO circuitry can engage in a repetitive cyclic behavior for communicating data from one board to another by (1) staying in a sleep mode as much as possible, (2) detecting exit from sleep mode, (3) rapidly transitioning to an active mode, (4) receiving input signals on input ports, (5) intelligently aggregating the received input signals, (6) transmitting the aggregated input signals over a high-speed serial link, (7) receiving the aggregated data signals via the high speed serial link, (8) disaggregating the received aggregated data signals, (9) creating a copy of the input signals, (10) outputting the copied input signals to output ports, and (11) rapidly transitioning to the sleep mode.

As defined herein, sleep mode refers to a low power mode in which the VPIO circuit is inactive and consumes minimal power.

As defined herein, active mode refers to a mode in which the VPIO circuitry is actively aggregating and transmitting data or receiving and disaggregating data and consuming power to do so.

As defined herein, instantaneous power consumption refers to a quantity of energy being consumed at any given moment in time. The instantaneous consumed power can fluctuate from low to high. Power consumption can be relatively high during full activity or almost zero during sleep mode or a low power mode.

As defined herein, average power consumption is an average of active, sleep, and low-power modes over a period of time. The average power can be calculated as follows: ACTIVE_TIME %*ACTIVE_POWER(mW)+LOW_POWER_TIME %*LOW_POWER(mW). ACTIVE_TIME % and LOW_POWER_TIME % are application and use case specific. To optimize power consumption ACTIVE_TIME % and ACTIVE_POWER(mW) should be minimized.

The VPIO circuitry includes one or more virtual pipe engine (VPE) circuits that facilitate data transfer for multiple communication ports (also referred to as “ports”) between two or more printed circuit boards or two or more devices, while adhering to stringent maximum power consumption requirements. Each board may include a virtual pipe I/O circuitry, with virtual pipe I/O circuitry providing an interface between multiple ports of coupled boards. Each VPE aggregates data of multiple ports that may use one or more of different communication protocols according to a configurable or “universal” communication protocol, and transfers the aggregated data over a wired or wireless communication link (or “virtual pipe”). VPIO circuitry allows a system to aggregate both low-speed and high-speed industry standard and proprietary protocols, for simultaneous transmission using the configurable or universal communications protocol over one or more links. The configurable or universal communication protocol may be firmware programmable that defines a sequence of ports or groups of ports from which data to be transmitted should be input and to which the received data should be output.

In a transmitter mode, the VPE circuit references the sequence or mapping of the ports (or group of ports) as defined by the firmware to generate output data according to the communication protocol by selecting the input data from the ports according to the sequence or mapping of the ports. In a receiver mode, the VPE circuit references the sequence of ports as defined in the firmware to disaggregate data received from the communication link into output data for each of the ports. The ports may use different communication protocols. The mapping of ports may be configurable according to the speed or other properties of the ports. Among other things, limitations caused by using multiple (e.g., legacy or standard) protocols, physical layers, or mechanical connectors are reduced. The pin mapping table may be programmed in a permanent manner or subject to change(s) prior to data transmission, or may be reprogrammed dynamically during data transmission. The VPE circuit may monitor for changes in the demands of the application or transferred data, and update the slot table accordingly.

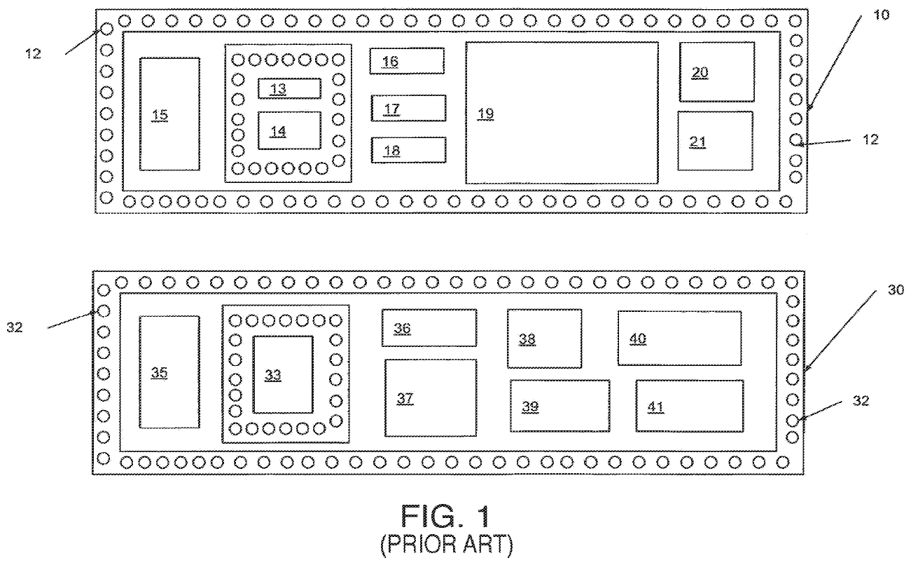

FIG. 1 shows two legacy circuit boards designed for a board-to-board connection via a conventional interposer connection. FIG. 1 shows board 10 with interposer pins/vias 12 surrounding the periphery of board 10 and components 13 and 14. Board 10 can also include circuitry 15, 16, 17, 18, 19, 20, 21. Components and circuitry can refer to various circuitry including, but not limited to processors, memory, graphics processors, power management, RF circuitry, etc. FIG. 1 also shows board 30 with interposer pins/vias 32 surrounding the periphery of board 30 and component 33. Board 30 can also include circuitry 35, 36, 37, 38, 40, 41. When board 10 is secured to board 30, interposer pins/vias 12 interface with interposer pins/vias 32 via an one more interposers (not shown) to form electrical connections between boards 10 and 30. In other words, board 10 may be soldered to an interposer (not shown), and the interposer, itself, is soldered to board 30. Each pin or via of the interposer is aligned to the pin or via of boards 10, 30 to perform valid electrical contacts. It should be understood that the number of interposer pins/vias and the location thereof, as well as the components and circuitry, are merely illustrative and that any suitable number of interposer pins/vias, components, and circuitry may be used. For illustrative purposes, the overall surface area of boards 10, 30, taken individually, is area, A₁.

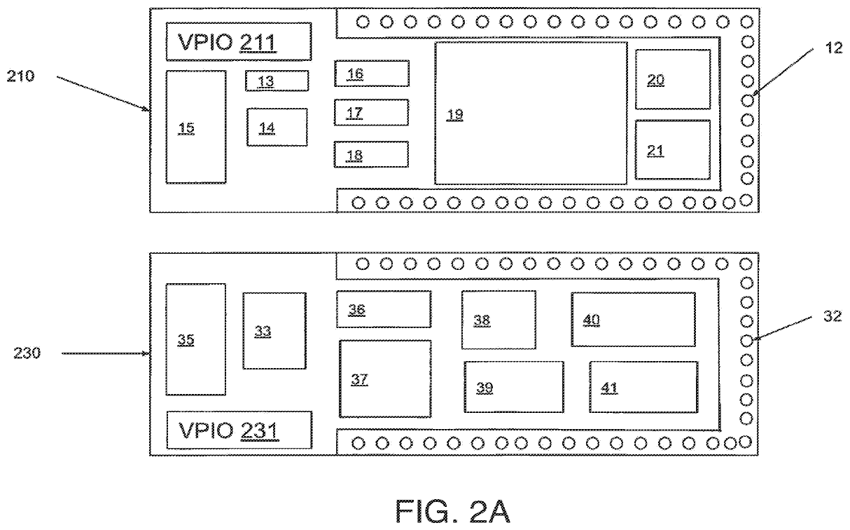

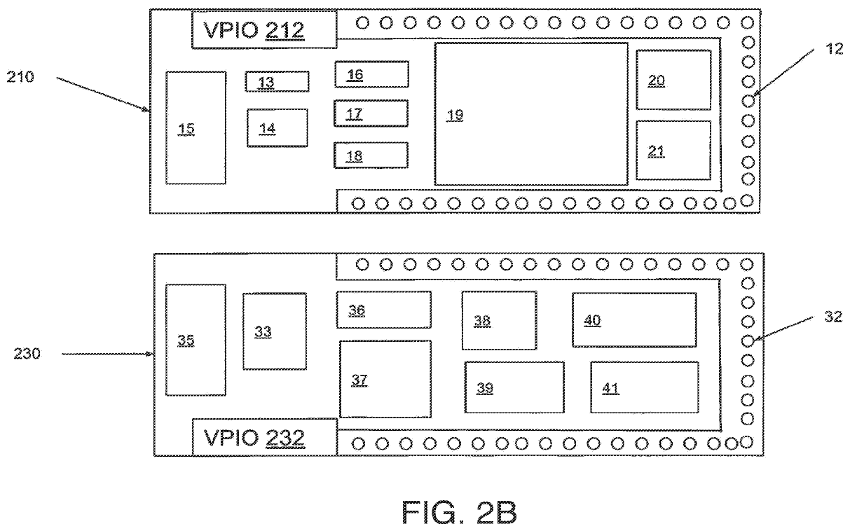

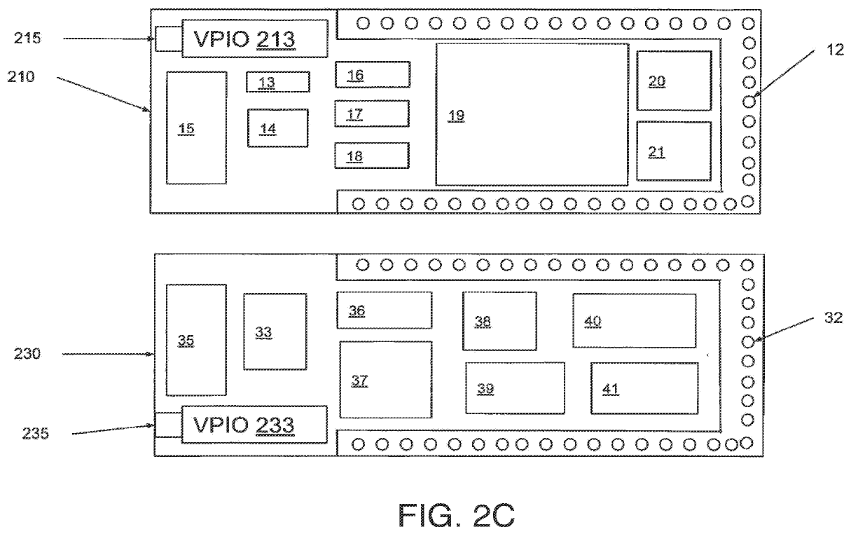

FIG. 2A shows two illustrative circuit boards configured for a board-to-board connection using interposer pins/vias and VPIO circuitry according to embodiments discussed herein. In addition, the same components and circuitry included in FIG. 1 are included in FIG. 2A for comparison. Inclusion of VPIO circuitry 211 on board 210 and VPIO circuitry 231 on board 230 eliminates many of the interposer pins/vias required on boards 10, 30 of FIG. 1. In addition, use of VPIO circuitry 211, 231 enables rearrangement of components 13, 14, 33, 34 and circuitry 15, 35, and an overall reduction in real estate required for boards 210, 230 as compared to boards 10, 30. When board 210 is connected to board 230, VPIO circuitry 211 interfaces with VPIO circuitry 231 and the interposer pins/vias of board 210 interface with the interposer pins/vias of board 230. For illustrative purposes, the overall area of boards 210, 230, taken individually, are A₂, where A₂ is less than A₁.

FIG. 2B is similar to the board-to-board connection of FIG. 2A with a difference in that circuitry 212 and VPIO circuitry 232 use one or more interposer pins/vias 12 and 32, respectively, to communicate with each other. This contrasts with FIG. 2A in which VPIO circuitry 211 directly interfaces with VPIO circuitry 231.

FIG. 2C is similar to the board-to-board connection of FIG. 2A and FIG. 2B with a difference in that VPIO circuitry 213 is connected to connector 215 and VPIO circuitry 233 is connected to connector 235, and connectors 215, 235 are connected to each other when boards 210, 230 are connected. In some embodiments, connectors 215, 235 can be wired connectors. In other embodiments, connectors 215, 235 can be wireless connectors (e.g., 60 GHz extremely high frequency connectors).

It should be appreciated that although FIGS. 2A-2C discussed different VPIO connections between boards (e.g., the direct VPIO circuitry connection, use of a connector connection, and use of the pins/vias connection), other connectors can exist on boards 210, 230 independent of any VPIO circuitry. It is the implementation of VPIO circuitry according to various embodiments discussed here that enables extraneous connectors and pins/vias to be eliminated. This is made possible through an aggregation-disaggregation feature of each VPIO circuit.

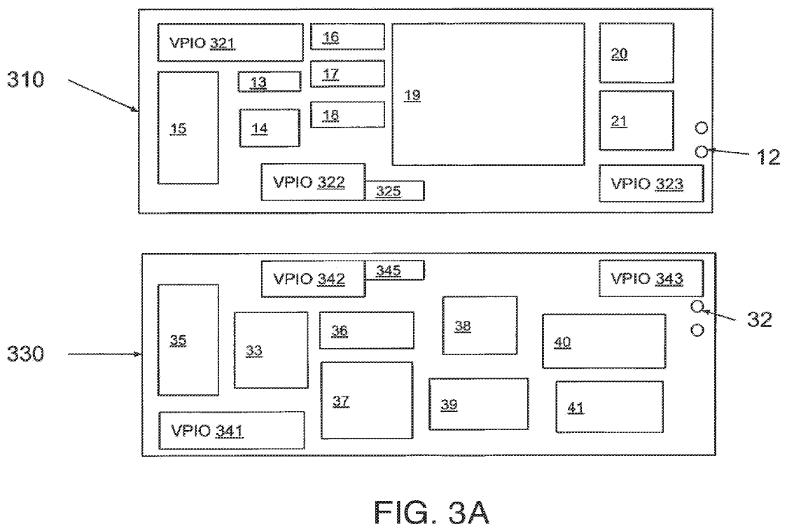

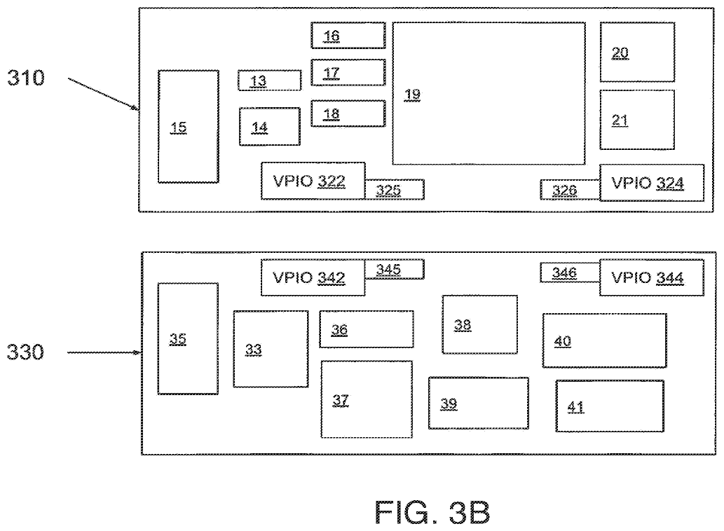

FIG. 3A shows two illustrative circuit boards configured for a board-to-board connection using interposer pins/vias, connectors, and VPIO circuitry according to embodiments discussed herein. In addition, the same components and circuitry included in FIGS. 1 and 2A-2C are included in FIG. 3A for comparison. Inclusion of VPIO circuitry 321, 322, 323 on board 310 and VPIO circuitry 341, 342, 343 on board 330 can eliminate all or nearly all of the interposer pins/vias required on boards 10, 30 of FIG. 1. In addition, use of VPIO circuitry 321, 322, 323, 341, 342, 343 enables rearrangement of components 13, 14, circuitry 15-21, components 33, 34, and circuitry 35-41, and an overall reduction in real estate required for boards 310, 330 as compared to boards 10, 30 (and boards 210, 230). VPIO circuitry 321 may interface directly with VPIO circuitry 341 when board 310 is connected to board 330. VIPO circuitry 322 may be connected to connector 325, and VPIO circuitry 342 may be connected to connector 345. When boards 310, 320 are connected, VPIO circuitry 322 and VPIO circuitry 342 can communicate with each other via connectors 325, 345, which can be wired or wireless connectors. VPIO circuitry 323 may use one or more pins/vias 12 to communicate through an interposer (not shown) that is connected to one or more pins/vias 32 to interface with VPIO circuitry 343. Interposer pins/vias 12 of board 310 can interface with the interposer pins/vias 32 of board 330. For illustrative purposes, the overall area of boards 310, 330, taken individually, is area, A₃, where A₃ is less than A₂. As will be appreciated, any combination of direct VPIO circuit to circuit, VPIO to connector, and VPIO to pins/vias can be implemented.

FIG. 3B shows an illustrative circuit board configuration similar to FIG. 3A, but all pins/vias have been eliminated and VPIO circuitry 322, 324, 342, 344 are connected to respective connectors 325, 326, 345, 346. Connectors 325, 326, 345, 346 can be wired or wireless connectors. Another difference between FIG. 3B and FIG. 3A is that VPIO circuitry 321, 341 have been eliminated.

A benefit of incorporating VPIO circuitry according to various embodiments is that the VPIO circuity frees up board space that would otherwise be occupied by interposer pins/vias or connectors. As discussed herein, the VPIO circuitry is designed and operative to satisfy latency and power requirements of a system that has traditionally used interposer pins/vias to carry board-to-board communications. In particular, the VPE enables the VPIO to emulate the functionality of interposer pins/vias or connectors by mapping any protocol pin (e.g., a GPIO, I2C, SPI, or UART) received by a first VPIO circuit (e.g., located on a first circuit board) to a corresponding protocol pin on a second VPIO circuit (e.g., located on a second circuit board). The VPIO circuit and VPE can accomplish this by abstracting the link layer associated with the protocol pin into format processable by the VPE, wherein the VPE serializes and/or encodes data received from the protocol pin prior to transmission via a wired connection to another VPIO circuit, which has a respective VPE to decode the encoded data and provide the decoded data to the corresponding protocol pin. In another embodiment, the VPE can include an aggregator and serializer but no encoder, and the counterpart VPIO module may be devoid of a decoder. To ensure low latency is achieved using VPIO circuitry in lieu of interposer pins/vias or connector, the VPE may use a pin mapping scheme and an interface mapping scheme to preset pin-to-pin/protocol-to-protocol correlations for the system in which the VPIO circuitry is being used. Moreover, the VPE may also use a low power exit and entry scheme to rapidly power up the VPIO circuitry, perform the necessary data transaction(s), and rapidly power down the VPIO circuitry.

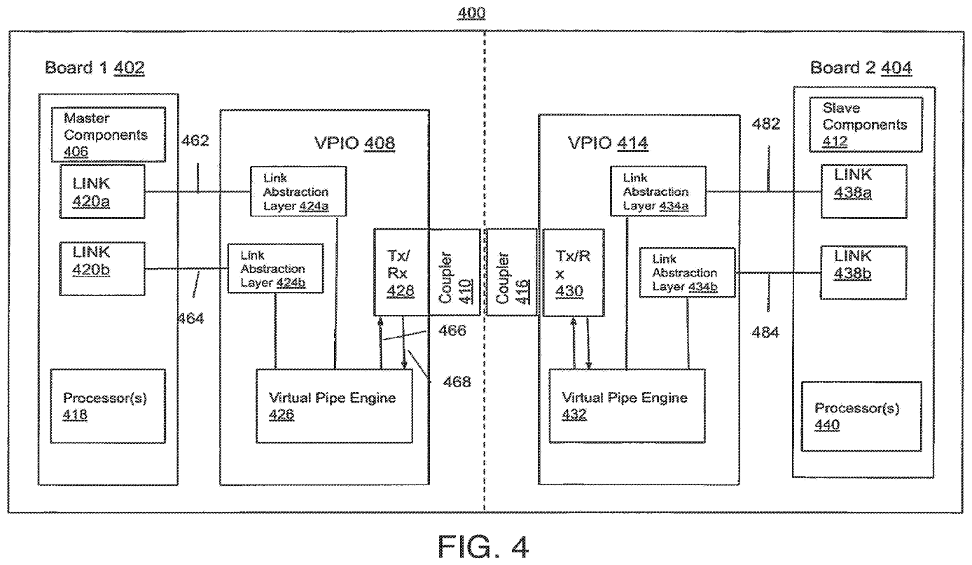

FIG. 4 shows a system or device 400 including printed circuit boards 402, 404 that have components and circuitry that communicate with each other, in accordance with some embodiments. Printed circuit board 402 may include master components 406, a virtual pipe I/O 408, and a wired coupler 410. Printed circuit board 404 may include slave components 412, a virtual pipe I/O 414, and a wired coupler 416. Wired couplers 410, 416 can be, for example, a wired connection, a connector, or an interposer that connects pins and vias among boards 402, 404. In some embodiments, couplers 410, 416 can enable direct connection between VPIO circuitry 408 and VPIO circuitry 414. In yet another embodiment, coupler 410 and coupler 416 can be wireless couplers capable of extremely high frequency (e.g., 60 gHz) contactless communication.

Master components 406 can be coupled to the virtual pipe I/O 408, and the virtual pipe I/O 408 is coupled to the wired coupler 410. The virtual pipe I/O 408 is an integrated circuit that is separate from master components 406 and wired coupler 410. Master components 406 can include one or more processors 418 (e.g., primary processor such as a system on a chip (SOC)), peripheral circuitry (not shown), and multiple data link layers (LINKs), such as LINK 420a and LINK 420b. In some embodiments, the processor(s) 418 and LINKs 420a, 420b are connected via circuit board 402. Virtual pipe I/O 408 is connected with LINKs 420a, 420b on circuit board 402. If desired, the virtual pipe I/O 408 can be integrated with various types of master components 406 without requiring modifications in master components 406. Each LINK 420a, 420b is a circuit that encodes bits into packets prior to transmission and decodes received packets back into bits; may provide reliable data transfer by transmitting packets with the necessary synchronization, error control and flow control; and may provide for logical link control, media access control, hardware addressing, error detection and interfacing with the physical link (PHY). Each LINK 420a, 420b may be divided into sublayers including but not limited to the media access control (MAC) sublayer and the logical link control (LLC) sublayer. Each LINK 420a, 420b may be a protocol layer (e.g., layer 2) of the open systems interconnection (OSI) model.

Each LINK 420a, 420b implements a port of the master component 406 for communication with a slave component located on board 404. For example, the LINK 420a provides a port 462, and the LINK 420b provides another port 464. Although two ports 462, 464 are shown for simplicity, the master components 406 may include various numbers of ports. The ports may include ports for intra-system communications (e.g., board 402 to board 404 communications) or external communications where master components 406 communicates with a different system or device. Processor(s) 418 may be coupled to each of the LINKs 420a, 420b to communicate via the ports 462, 464. Different ports may use different protocols, including high-speed protocols and low-speed protocols. In some embodiments, one or more LINKs 420a, 420b may be integrated with the processor(s) 418 (e.g., as a driver).

Virtual pipe I/O 408 is a circuit that provides for data transfer between master components 406 and the virtual pipe I/O 414 of the printed circuit board 404. The virtual pipe I/O 408 may operate in a transmitter mode, a receiver mode, or a transceiver mode. In the transmitter mode, the virtual pipe I/O 408 provides for aggregation of data from the ports 462, 464 of the master components 406 for transmission via the wired coupler 410. In the receiver mode, the virtual pipe I/O 408 parses data from the wired coupler 410 for transmission to the master components 406 via the ports 462, 464. In the transceiver mode, the virtual pipe I/O 408 operates as a transmitter and a receiver simultaneously. For example, one or more ports may be dedicated to transmitting while one or more other ports may be dedicated to receiving.

Virtual pipe I/O 408 includes link abstraction layers, such as link abstraction layer 424a and link abstraction layer 424b, a virtual pipe engine (VPE) 426, and a transceiver (Tx/Rx) 428. The virtual pipe I/O 408 is coupled to the LINKS 420a, 420b of the master components 406 via the link abstraction layers 424a, 424b of the virtual pipe I/O 408. Each LINK 420a, 420b of the master components 406 is coupled to a corresponding link abstraction layer 424a, 424b of the virtual pipe I/O 408 to connect a port to the VPE 426. Each link abstraction layer 424a, 424b may be adapted to communicate with the master components 406 via a transmission medium, such as a cable, suitable for the protocol of the ports 462, 464.

In some embodiments, each link abstraction layer 424a, 424b: includes a physical layer (or PHY) that provides an electrical interface for connection to a LINK 420a, 420b via a transmission medium (e.g., a cable); defines physical characteristics such as connections, voltage levels and timing; and defines the means of transmitting raw bits rather than logical data packets over a physical link. The bit stream may be grouped into code words or symbols and converted to a physical signal that is transmitted over the transmission medium. Each link abstraction layer 424a, 424b may include a standards-based PHY that incorporates PHY specifications of one or more standard protocols. Examples of standard protocols may include Universal Serial Bus (USB), DisplayPort, I2C, GPIO, PCIe 3, PCIe sideband, MIPI, or Next Gen Camera Protocol. Each PHY may be a physical layer (e.g., layer 1) of the Open System Interconnection (OSI) model.

The VPE 426 is a circuit that controls the operation of the virtual pipe I/O 408. The VPE 426 is connected to multiple ports 462, 464 of the master components 406 via the link abstraction layers 424a, 424b. In the transmitter mode, the VPE 426 receives input data from each of the ports 462, 464 and aggregates the input data to generate output data 466. In particular, VPE 426 generates the output data 466 based on selecting the input data from the ports 462, 464 according to a sequence of the ports as defined in a mapping scheme. The aggregated output data 466 is provided to transceiver 428 for transmission by wired coupler 410 via a wired connection. In the receiver mode, VPE 426 receives input data 468 from the transceiver 428, and parses or disaggregates the input data 468 according to the sequence of the ports defined in the mapping scheme to generate output data for each of ports 462, 464. The input data 468 is transmitted via respective ports to the master components 406 via link abstraction layers 424a, 424b and LINKs 420a, 420b. The input data 466 and output data 468 are shown as being transmitted via separate connections in FIG. 4 to illustrate bi-directional data transfer, but in some embodiments the input data 466 and output data 468 may be transmitted using the same connection. The plurality of input data 462 and output data 464 are shown as being transmitted via separate connections in FIG. 4 to illustrate bi-directional data transfer, but in some embodiments the plurality of input data 462 and output data 464 may be transmitted using the same connection.

The sequence of ports in the mapping scheme defines a common communication protocol shared by the master components 406 and the slave components 412 for aggregating and parsing data transmitted through the virtual pipe I/Os 408, 414. The common communication protocol integrates data from multiple ports that may use different (e.g., standard) communication protocols. In some embodiments, the VPE 426 performs additional processing of data that uses the common communication protocol, such as applying encryption, decryption, authentication, and/or error correction, for example. The VPE 426 may define the sequence of ports in the mapping scheme based on the bandwidth demand of applications or transferred data, and may dynamically adjust (e.g., during data transfer) the sequence of ports in the mapping scheme in response to changes in bandwidth demand.

Transceiver 428 transfers data between wired coupler 410 and VPE 426. Transceiver 428 may include a transmitter with a serializer, and a receiver with a deserializer. When operating as a transmitter, the serializer converts parallel streams of output data 466 from VPE 426 into a serial stream of output data that is transmitted to wired coupler 410 for wired transmission. When operating as a receiver, the deserializer converts a serial input stream from wired coupler 410 into parallel streams of input data 468 which is transmitted to VPE 426. In some embodiments, the virtual pipe I/O 408 may include a separate transmitter and receiver.

Wired coupler 410 (in connection with wired coupler 416) provides a wired communication link between virtual pipe I/O 408 of board 402 and virtual pipe I/O 414 of the board 404. Wired coupler 410 and wired coupler 416 can be wired connectors.

In some embodiments, wired coupler 410 and wired coupler 416 may be replaced with respective EHF couplers. An EHF coupler is an EHF communication device that includes an antenna for wireless transmissions. The antenna may be configured to operate in an EHF spectrum (30 GHz to 300 GHz), and may be configured to transmit and/or receive electromagnetic signals through the communication link. In some embodiments, an EHF coupler can perform modulation of transmitted data with a carrier signal and demodulation of a received signal to generate received data.

The discussion regarding board 402 may be applicable to board 404. For example, virtual pipe I/O 414 may operate like virtual pipe I/O 408 in the transmitter, receiver modes, or transceiver modes. When virtual pipe I/O 408 operates in the transmitter mode, virtual pipe I/O 414 operates in the receiver mode. Similarly, virtual pipe I/O 408 operates in the receiver mode when virtual pipe I/O 414 operates in the transmitter mode. As such, virtual pipe I/O 414 includes a transceiver 430 coupled to the wired coupler 416, and a VPE 432 coupled to multiple link abstraction layers, such as link abstraction layer 434a and link abstraction layer 434b. Each link abstraction layer 434a, 434b is coupled to a respective LINK 438a, 438b of the slave components 412. Slave components 412 include the LINKs 438a, 438b to provide a port 482, 484, and one or more processors 440. Virtual pipe I/Os 408, 414 provide a communication link between the master components 406 and the slave components 412.

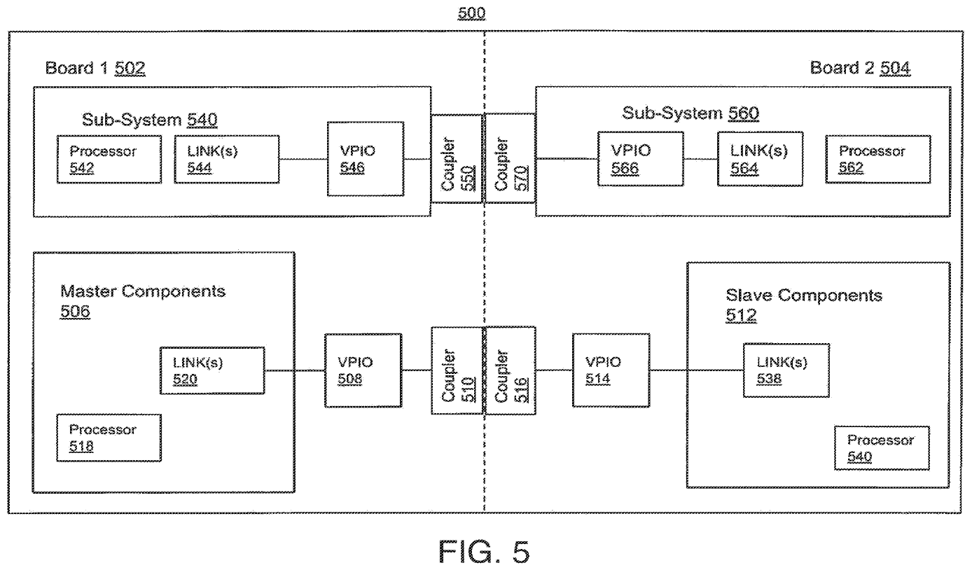

FIG. 5 shows a system or device 500 including printed circuit boards 502, 504 that have components and circuitry that communicate with each other, in accordance with some embodiments. FIG. 5 shows two different VPIO circuitry configurations: one in which the VPIO circuitry exists independent of a sub-system or other integrated system existing on the printed circuit board (similar to what is shown in FIG. 4); and another in which the VPIO circuitry is integrated with a sub-system or some other integrated system existing on a printed circuit board. FIG. 5 shows an embodiment in which two or more different pairs of VPIO circuitry (e.g., integrated VPIO circuitry and independent VPIO circuitry) can be included in a system or device to replace interposer pins/vias. The integrated VPIO circuitry can provide a highly customized interconnect solution for the sub-system (e.g., a system on a chip) and the independent VPIO circuitry can provide a rapid interconnect design and deployment solution. A simplified representation of FIG. 4 is included in FIG. 5 as master components 506, VPIO circuitry 508, wired coupler 510, wired coupler 516, VPIO circuitry 514, and slave components 512. Master components 506 can include one or more LINKS 520 and one or more processors 518. Slave components 512 can include one or more LINKS 538 and one or more processors 540. VPIO circuitry 508 and VPIO circuitry 514 can each include respective link abstraction layers, a transmitter/receiver, and/or a VPE, all of which have been omitted to avoid cluttering the drawing.

The VPIO integration is shown by a sub-system 540, a wired coupler 550, a sub-system 560, and a wired coupler 570. Sub-system 540 can include processor 542, LINKs 544, and VPIO circuitry 546, and sub-system 560 can include processor 562, LINKs 564, and VPIO circuitry 566. Here, VPIO circuitry 546 and VPIO circuitry 566 may be integrated logical components of sub-system 540 and sub-system 560, respectively. LINKs 544, 564 can be similar to LINKs 420a, 420b, 438a, 438b of FIG. 4. The configuration of VPIO circuits 546, 566 may be similar to or different than the configuration of VPIO circuits 408 or VPIO 414. For example, each of VPIO circuits 546, 566 may include a VPE, transmitter/receiver, and link abstraction layer(s).

It should be understood that the VPIO circuitry pairs shown in FIG. 5 are merely illustrative and additional pairs of any type may be added or that a pair may be omitted. For example, two pairs of integrated VPIO circuits may exist within a device or system. As another example, two pairs of independently standing VPIO circuits and one pair of integrated VPIO circuits may exist within a device or system.

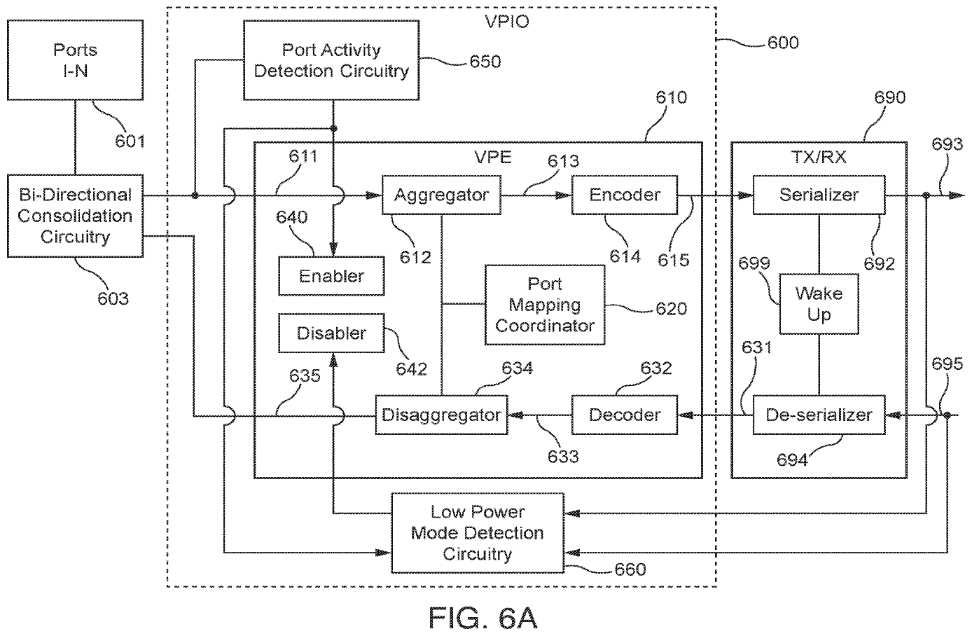

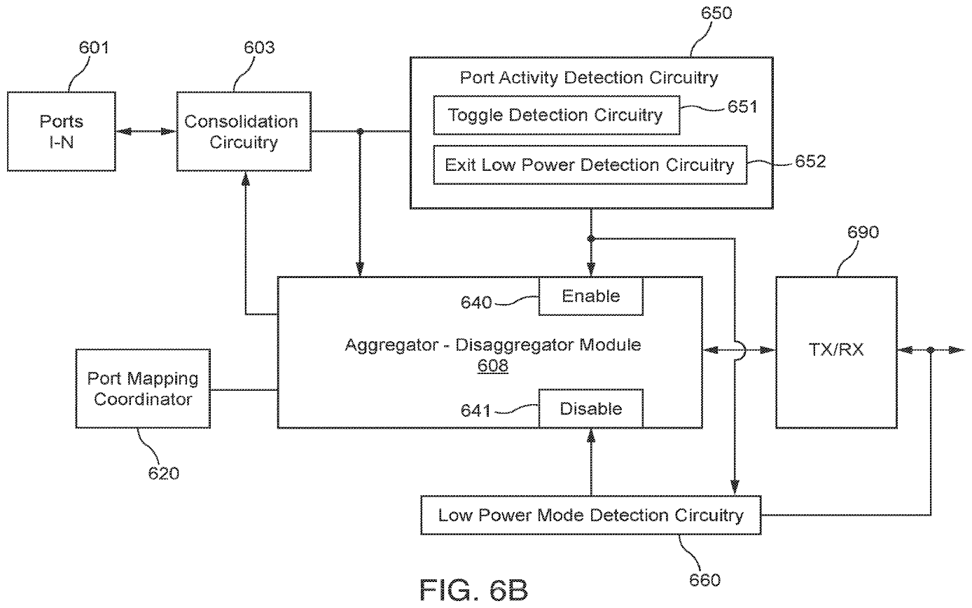

FIG. 6A shows an illustrative VPIO circuitry 600 in accordance with an embodiment. VPIO circuitry 600 is connected to ports 601 via bi-directional consolidation circuitry 603 and transmitter/receiver 690. VPIO circuitry 600 is an example of VPIO circuitry shown in FIGS. 2A-2C, 3A, 3B, 4, and 5. VPIO circuitry 600 can include VPE 610, port activity detection circuitry 650, and low power mode detection circuitry 660. VPE 610 can include aggregator 612, encoder 614, port mapping coordinator 620, decoder 632, disaggregator 634, enabler 640, and disabler 642.

It is desirable for VPIO circuitry 600 to remain in a low power or sleep mode as much as possible. Circuitry 600 includes specific circuitry to ensure minimal power consumption using several approaches. In one approach circuitry 600 can shut down all or a subset of the clocks (not shown) when in low power mode. In another approach, the transition from low power to active power can occur substantially immediately. This may be achieved using port activity detection circuitry 650. In yet another approach, the transition from active power to low power can occur substantially immediately. This may be achieved using the low power mode detection circuitry 660. Furthermore, the duration of the active mode is minimized versus time spent in low power mode. This can be achieved by utilizing a high-speed communications link between two counterpart VPIO circuits that collectively process the data. In yet a further approach, the use of clocked functions in active mode can be minimized as much as possible to minimize the dynamic power consumption that is preponderant in active mode. Its value is C*V²*f, with C capacitance, V the power supply voltage, and f the clock frequency.

Typically, when VPE 610 exits out of sleep mode, one or more local clock oscillators can be awakened. The time for awakening the local oscillators is preferably minimized because the longer it takes, VPE 610 is neither in active mode, nor completely woken up, and is needlessly consuming energy. In some embodiments, VPIO circuitry 600 may sleep and wake up cyclically with a ratio of 100:1, consuming power mostly within 1% of the time when active. However, if the time required to wake-up the oscillators results in a sleep/wake up cycle ratio of 50:1, this doubles the average power consumption. Thus, the longer the transition to enter or exit low power mode takes, the more energy wasted. Circuitry 650 and circuitry 660 are designed to minimize the amount of time required to enter and exit low power mode.

Ports 601 can represent N number of ports that are connected to VPIO circuitry 600 via bi-directional consolidation circuitry 603. Transmitter/receiver (or transceiver) 690 can transmit and receive data serially over a high-speed bus. Transceiver 690 is connected to a high-speed link that is wired or wireless. Transmitter/receiver 690 can include serializer 692 that converts data received as a parallel data stream into a serial data stream sent as output stream on bus 693 and a de-serializer 694 that converts data received as serial input data stream on bus 695 into a parallel data stream. In some embodiments, transceiver 690 can include wake up block 699 that is operative to cause serializer 692 to send a “wake up” signal to its counterpart de-serializer in another transceiver to activate operation of that other transceiver, which in turn, can activate the VPIO circuitry associated with the other transceiver. Wake up block 699 can activate VPE 610 by providing a signal to enabler 640 in response to de-serializer 694 detecting a “wake up” signal (which is transmitted by a counterpart transceiver) on bus 695.

Ports 601 can be connected to port activity detection circuitry 650, aggregator 612, and disaggregator 634 via bi-directional consolidation circuitry 603. Not shown in FIG. 6 are link abstraction layers that may be associated with each port. An output of port activity detection circuitry 650 can be connected to enabler 640 and to low power mode detection circuitry 660. Low power mode detection circuitry 660 may be coupled to high speed transmit bus 693 and to high speed receive bus 695. An output of circuitry 660 can be connected to disabler 642.

Port activity detection circuitry 650 is operative to detect activity on each of ports 601 using clockless signal detection and activate VPE 610 when any activity is detected on any of ports 601. Circuitry 650 can trigger enabler 640 to activate any state machine(s), clock(s), or other circuitry within VPE 610 so that the functions of VPE 610 are available to process data. Port activity detection circuitry 650 can also detect activity on output 635 (which is derived from disaggregator 634) via consolidation circuitry 603.

In another implementation, port activity detection circuitry 650 is operative to detect activity on each of ports 601 using a low power clocked signal detection.

In yet another implementation, port activity detection circuitry 650 is operative to detect activity on each of ports 601 using a gated clocked signal detection. The enable signal to control the gated clock may be activated with a set of pre-determined conditions. For example, the enable pin may be driven by an upper function at system level in the circuitry of FIG. 6A that may wait for incoming traffic in a predetermined time window. In one embodiment, the upper layer may have started a low power timer that wakes up the enable signal after a certain period of time.

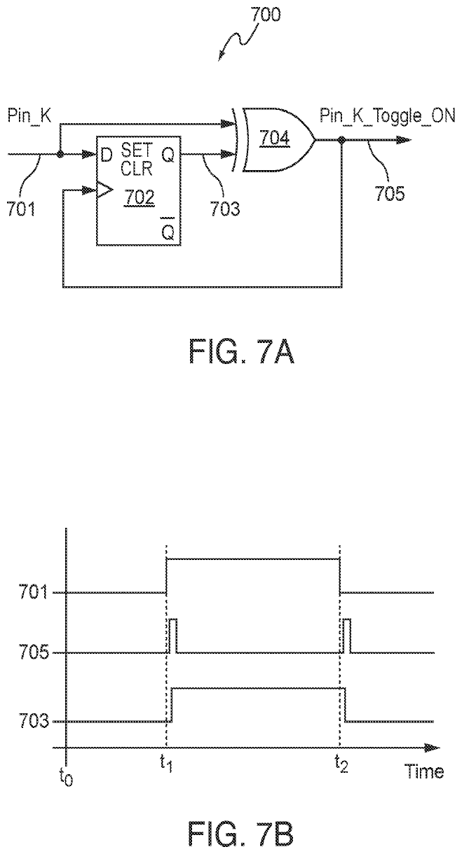

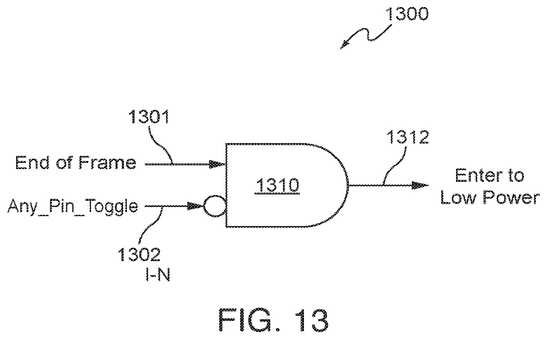

Circuitry 650 is designed to rapidly activate VPE 610 by causing the VPE 610 to transition from a sleep mode to an active mode. FIGS. 7A-12, below, describe different circuit implementations of circuity 650. VPE 610 is primarily kept in sleep mode (e.g., a low power mode) unless VPE 610 is needed to process data. As explained above, keeping VPE 610 in sleep mode minimizes power consumed by VPIO circuitry 600. In addition, the ability to rapidly transition from active mode to sleep mode is another way to minimize power consumption. Low power mode detection circuitry 660 is operative to detect when VPE 610 is no longer needed to process data and can rapidly disable VPE 610 by asserting disabler 642, which causes VPE 610 to immediately enter into the sleep mode. Circuitry 660 may cause VPE 610 to be disabled when an end of frame signal is detected in Tx and Rx directions (e.g., on output stream 693 or input stream 695) and there is no activity on any of ports 601. FIG. 13, below, describes a circuit implementation of circuitry 660.

In response to detecting signal activity on any one of more of ports 601, VPE 610 is activated by circuitry 650 and aggregator 612 and programmable encoder 614 are activated to transfer data from ports 601 to the transceiver 690, which serializes the data to be transmitted over bus 693. Aggregator 612 is coupled to ports 601 and port mapping coordinator 620. Port mapping coordinator 620 can include a permanently configured mapping scheme or a dynamically configurable mapping scheme that defines a sequence of the ports. The mapping scheme may control a switch matrix that remaps a port on one board to another port on another board. In some embodiments, a data buffer (not shown) can receive input data 611 from ports 601 and can store input data 611. In some embodiments, the data buffer includes a first-in first-out (FIFO) memory for each of ports 601 that stores input data 611 received from ports 601. Aggregator 612 selects and aggregates input data 611 received from ports 601 (or from the FIFO memories of the data buffer) according to the mapping scheme defined in port mapping generator 620 to generate output data 613.

Programmable encoder 614 receives output data 613 from aggregator 612 and performs an encoding or other processing to generate output data 615. In some embodiments, the programmable encoder 614 performs authentication and/or error correction. In some embodiments, the programmable encoder 614 may be bypassed, deactivated, or omitted from the VPE 610. Transceiver 690 receives output data 615 and generates an output stream 693 for a wired connector or other communication component, such as an EHF coupler.

If data is being received by transceiver 690, decoder 632 and disaggregator 634 can be activated to transfer received data to ports 601. Bi-directional communication between ports 601 and transceiver 690 is made possible coupling aggregator 612 and disaggregator 634 to ports 601 via bi-directional consolidation circuitry 603. Transceiver 690 receives input stream bus 695 from wired connector or other communication component, such as an EHF coupler. De-serializer 694 converts input stream 695 into parallel stream of input data 631. Programmable decoder 632 receives input data 631 and performs decoding or other processing to generate input data 633. For example, the input data 631 may be generated by another VPE of another VPIO circuit (e.g., on another board) that applies an encoding algorithm in its transmitter mode prior to transmission, and programmable decoder 632 may decode the received input data 631 by applying a corresponding decoding algorithm. In some embodiments, the programmable decoder 632 performs authentication and/or error correction. In some embodiments, programmable decoder 6324 may be bypassed, deactivated, or omitted from the VPE 610.

Disaggregator 634 receives input data 633 from programmable decoder 632 and generates output data 635 by parsing the input data 633 according to the mapping scheme defined in port mapping coordinator 620. Output data 635 is provided to the appropriate ports 601. In some embodiments, output data 635 can be stored in a data buffer, which provides output data 635 to respective ports 601. In some embodiments, the data buffer includes a FIFO memory for each port that stores the output data that is provided to the ports.

Enabler 640 and disabler 642 may be part of a controller (not shown) that controls the operation of VPE 610. The controller can manage state machine(s) or clock(s) that control operation of VPE 610. The controller may control the mode of operation including transmitter only, receiver only, or transceiver modes.

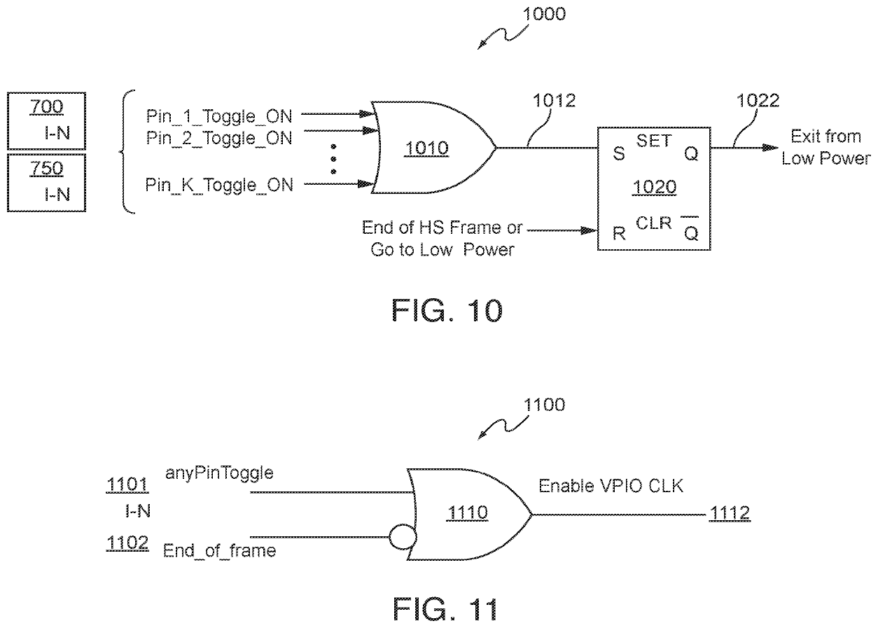

FIG. 6B shows a simplified and alternative version of FIG. 6A according to some embodiments. The main difference between FIG. 6B and FIG. 6A is that the VPIO circuitry 600 and VPE 610 designations are removed and replaced with a generic aggregator-disaggregator module 608. Components in FIG. 6 B having the same reference numerals as those in FIG. 6A need not be redescribed. Aggregator-disaggregator module 608 can perform the same aggregating and disaggregating functions as VPE 610, can be instructed to exit of out low power mode by port activity detection circuitry 650, can enter low power mode by low power mode detection circuitry 660. Port mapping coordinator may maintain a port mapping scheme for aggregator-disaggregator module 608. Detection circuitry 650 has been altered to include toggle detection circuitry 651 and exit low power detection circuitry 652 as these two circuitry components may collectively enable operation of port activity detection circuitry 650. Toggle detection circuitry 651 may be used to detect signal activity on a port. Examples of toggle detection circuitry 651 are discussed below in connection with FIGS. 7A, 8A, and 9. Exit low power detection circuitry 652 may be used to instruct aggregator-disaggregator module 608 to exit low power. Examples of exit low power detection circuitry 652 are discussed below in connection with FIGS. 10 and 11.

FIG. 7A shows an illustrative circuit schematic of a portion of port activity detection circuitry 700 according to an embodiment. For example, circuitry 700 can be used with circuity 1000 of FIG. 10 or circuitry 1100 of FIG. 11 collectively to represent port activity detection circuitry 650 of FIG. 6. In some embodiments, circuitry 700 be referred to herein as toggle detection circuitry in that it is designed to detect a signal transition or signal activity on any given port. Circuitry 700 can detect a change of state at the input signal Pin_K 701 without the use any clock—internal or external—which advantageously minimizes the power consumption in low power or sleep mode. Pin_K 701 is connected to a port (e.g., one of ports 601). As such, for each port that is connected to VPIO circuitry, a separate circuitry 700 is included. For example, if fifty (50) ports are routed to a VPIO circuitry, fifty (50) separate instances of circuitry 700 are required. A D flip-flop 702 is connected to the pin of the input signal Pin_K 701. Flip-flop output 703 is connected to a first input of XOR 704 gate. A second input of XOR gate 704 is connected to input signal 701. An output 705 of XOR gate 704 is connected to the clock input of flip-flop 702. Output 705 also provides the Pin_K_Toggle_ON signal that is used to rapidly wake up the VPE (e.g., VPE 610). It is assumed that flip-flop 702 is reset and its output 703 is “0” at initialization. While the input signal is “0”, output 705 is “0”. If input signal 701 changes its state to “1”, XOR gate 704 compares the input 701 with a “0” at flip flop output 703 and transitions its output to “1” at output 705. This “0” to “1” positive transition is applied to the clock input of flip flop 702 and causes flip flop 702 to changes its output state 703 to “1”. XOR gate 704 compares “1” provided by input signal 701 and “1” provided by output signal 703 and causes output 705 to transition back to “0”. When a negative transition on output 705 transitions from “1” to “0”, the “0” applied to the clock input of flip flop 702 does not change the state of flip-flop 702 and therefore its output 703 stays at “1”. The result at the output Pin_K_Toggle_ON 705 is a pulse “010” that signals that a transition has been detected at Pin K 701. Furthermore, if the input signal 701 goes back to “0” afterwards, the XOR gate outputs a positive transition to “1” at output 705 because flip flop output 703 is still “1”. This positive transition activates flip-flop 702 and output 703 changes to “0”. Consequently, the output 705 of XOR gate 704 transitions back to “0”. At this point, any positive or negative transition at input signal 701 creates a pulse at output 705 of circuitry 700.

FIG. 7B shows an illustrative timing diagram showing operation of port activity detection circuitry 700 according to an embodiment. FIG. 7B shows traces for input signal 701, flip flop output 703 and XOR gate output 705. At time, t0, signals 701, 703, and 705 are all “0”. At time, t1, input signal 703 transitions from state “0” to “1”. This transition causes output signal 705 to transition from state “0” to “1”. The “1” is fed back to the clock input of flip flop 702, which causes output 703 to transition from “0” to “1”. XOR gate output 705 transitions from “1” to “0” when the “1” from input signal 701 and the “1” from output signal 703 are input to XOR gate 702. Signals 705 and 703 remain fixed until a new change of state appears at the input 701 at time t2, shown as a “1” to “0” negative transition. As this point in time, XOR gate 704 has a “0” and “1” at its inputs, and its output 705 transitions back to “1” and the pulse cycle restarts.

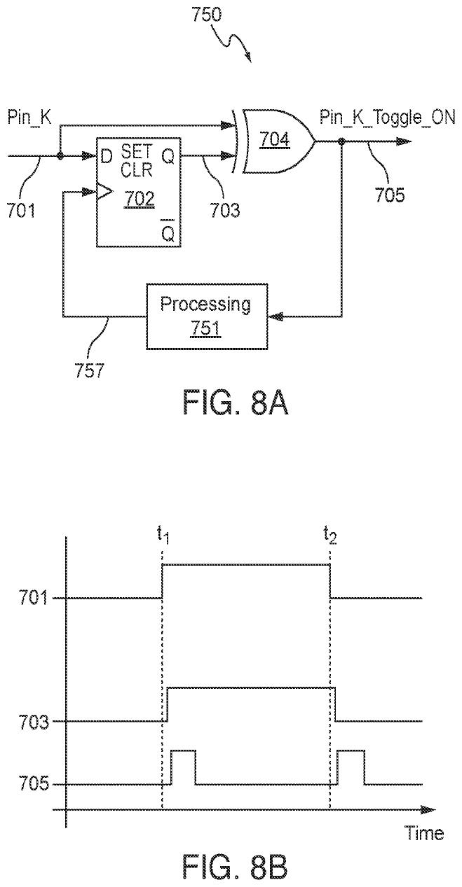

FIG. 8A shows alternative port activity detection circuitry 750 according to an embodiment. Circuity 750 is similar to circuitry 700, but has added processing component 751 between XOR gate output 705 and the clock input of flip flop 702. The operation of circuitry 750 is essentially the same as circuitry 700, except the processing component 751 increases the duration of the “010” pulse by extending the duration of the “1” portion of the pulse. This provides extra time for VPIO circuitry to detect the “010” transition and activate the necessary components. In some embodiment, processing component 751 can include a delay element, a state machine, a clock gated delay, a de-glitcher, a glitch filter, a noise filter, a pulse minimum length detection, a pulse processing, and a processing unit. Processing component 751 extends the “1” portion of the “010” pulse by delaying assertion of the “1” signal being applied to the clock input 757 of flip flop 702. FIG. 8B shows an illustrative timing diagram showing how the “010” pulse is extended using processing component 751 in circuitry 750 according to an embodiment.

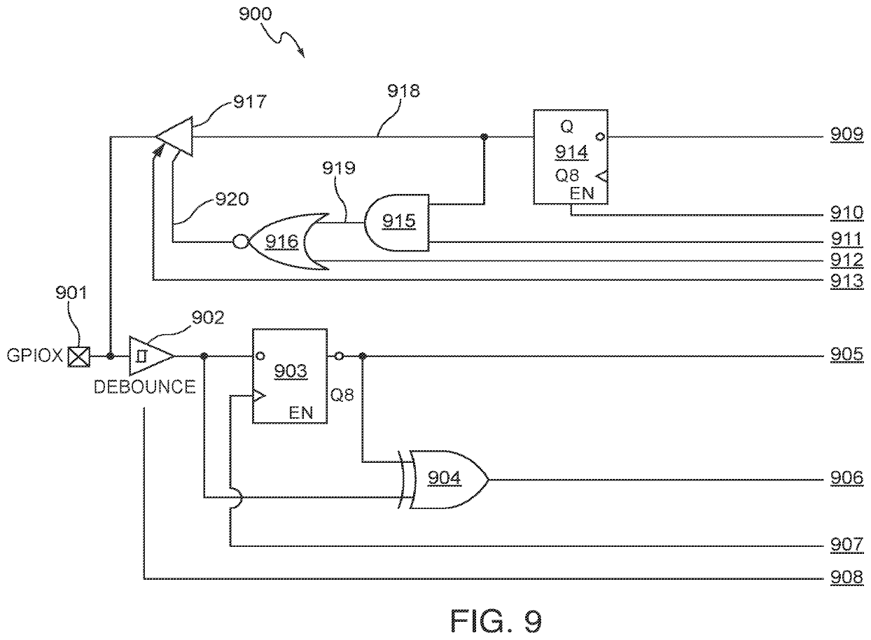

FIG. 9 shows an illustrative bidirectional port activity detection circuitry 900 according to an embodiment. Circuitry 900 can be considered herein as toggle detection circuity operative detect signal activity on a port. Circuitry 900 can be used in VPIO circuitry implementations that require bidirectional communication and a status of the state of the signal must be maintained on both the master and the slave sides, such as, for example, the master and slave boards shown in FIG. 4. Bidirectional means that the flow of communication goes both ways from the master to slave or vice versa from the slave to the master. An example of bidirectional signal is the protocol I2C. The I2C bus includes clock and data signals. The clock can be put on hold from both sides or multiples sides and the communication flows in several directions sequentially. For such a signal or protocol, the counterparts VPIO circuits (e.g., VPIO 408 and VPIO 414) require that the single wire or bus be reconnected in each VPIO circuit to allow communications in either direction.

Port 901 can be, for example, a general purpose input output (GPIO) port. GPIO ports are typically associated with a signal having low to middle speed of communication. The direction of communication is left to right from port 901 to debounce circuit 902, D flip flop 903, having output 905 and clock 907, and XOR gate 904 having inputs from debounce circuit 902, and flip flop 903. The debounce circuit is activated with the control signal 908. Communications spanning from right to left include signal 909, D flip flop 914 having output signal 918, signal 911, AND gate 915 having output signal 919, signal 912, NOR gate 916 having output signal 920, driver 917, and port 901. D flip flop 914 may be activated by signal 910 and driver 917 has slew rate determined by signal 913. The value driving the pin 901 by driver 917 is determined by the output 918 of D flip flop 914. The driver 917 is disabled when signal 912 is high by operating NOR gate 916 to drive output 920 low into driver 917 enable. When signal 911 is high, and signal 912 is low (allowing the driver to be enabled), the driver is enabled with output 901 value being zero when D flip flop 914 output 918 is zero. When D flip flop 914 value is one, the output 919 of AND gate 915 is one, which causes NOR gate 916 output 920 to be zero, disabling the driver. This causes the pin 901 to ‘float,’ or follow any input signal that is present at the pin. This is conventionally used for “wired AND” or “OR-tied” busses where a plurality of devices (including that such as a device containing Port 901) can participate in bidirectional communications by only driving low or not driving such the bus “floats” high by pulling the bus to one using a resistor.

Debounce circuit 902 serves to avoid switching up or down when a noisy signal or a signal with a slow transition slope is provided as an input. Debounce circuit 902 may affect this using a digital or analog low-pass filter to smooth out or ignore rapid input changes. Debounce circuit 902 may also include a Schmitt trigger to avoid output chatter when the input 901 or subsequently filtered signal has a slow rise time. Debounce circuity 902 may be deactivated with the signal 908 to improve response time. Flip flop 903 and XOR gate 904 collectively function similarly to circuitry 750 of FIG. 8A where the processing block 751 is performed externally as an acknowledgement that the change registered by D flip flop 903 and XOR gate 904 has been consumed by the VPIO circuitry and thus transmitted. Clock signal 907 is used by D flip flop 903 to copy the input value at pin 901 filtered by debounce circuit 902 to output 905, clearing the change condition indicated by XOR gate 904 output 906.

FIG. 10 shows illustrative port activity detection circuitry 1000 according to an embodiment. For example, circuitry 1000 can be used in conjunction with toggle detection circuitries 700, 750, 800, and 900. Circuitry 1000 uses a clockless design to minimize power consumption and provides a signal that enables the VPIO circuitry to exit from a low power or sleep mode. Circuitry 1000 can include OR gate 1010 that receives N number of Toggle_ON outputs from N instances of circuitry 700, 750, 800 or 900 as inputs and generates an output signal 1012 that is provided to the S input of a RS flip flop 1020. The RS flip flop 1020 can receive an End of Frame or Go to Low Power signal at its R input. An End of Frame signal may be included at the end of a packet in serial stream transmitted or received by a transceiver (e.g., transceiver 690). A Go to Low Power signal may be received from a lower power mode detection circuit (e.g., circuitry 660).

During operation, when a port has signal activity, this signal activity is detected by a respective one of circuitries 700, 750, 800 or 900, which outputs a “010” pulse. This pulse is fed to the S input of SR flip flop 1020 and causes output 1022 of SR flip flop 1020 to transition to a “1” when “1” is applied to the S input. The R input is “0” when the End of Frame or Go to Low Power signals have been detected. Output 1022 is the “Exit from Low Power” signal that can be used by the VPIO circuitry to exit the low power or sleep mode.

FIG. 11 shows illustrative port activity detection circuitry 1100 according to an embodiment. Circuitry 1100 can process inputs and create a signal that can be used by the VPIO circuitry to exit the low power or sleep mode. Circuitry 1100 can include an OR gate 1110 with signals 1101_{1-N} as a set of first inputs and an End of Frame signal 1102 as a second input with an inversion. Signals 1101_{1-N} can be derived from the output of respective instances of circuitry 700, 750, 800 or 900. Until an End of Frame signal 1102 is reached (not in low power mode), output signal 1112 is active at “1” and cannot be shut down. However, when the end of frame is reached (without additional input signal toggles on signals 1101_{1-N}) the VPIO circuitry can go into low power mode and will exit low power mode when toggles are detected on signals 1101_{1-N}. Output 1112 provides the signal Enable_VPIO_CLK that can cause one or more of the following actions: (1) power ON a VPIO clock to activate a VPIO circuit; (2) enable the VPIO clock (which was previously powered ON) to be used by some or all the VPIO circuitry; and (3) used by the VPIO circuitry to exit the low power mode.

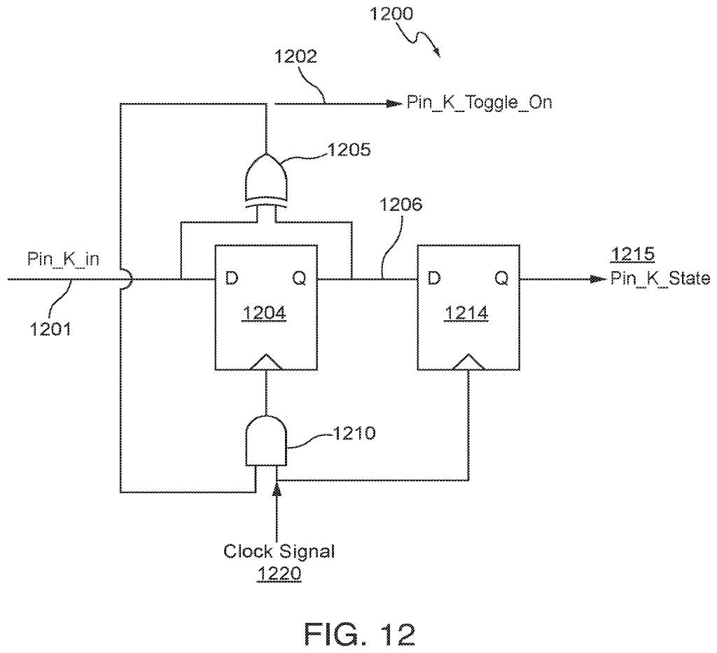

FIG. 12 shows illustrative port activity detection circuitry 1200 according to an embodiment. Circuitry 1200 may build on circuitry 750 of FIG. 8A to address potential issues of metastability. When a signal is sampled by a clock in an asynchronous fashion, there is a low but not zero probability that the clock signal and the input signal change state at the same time or almost at the same time, thereby disrupting setup time requirements of a flip-flop. Long hesitation or false logical state on the output can be the result, and this is called metastability. In instances of metastability, the output state may be erroneous (logical state “0” vs. a state “1” for instance or vice and versa) and the metastability with a forbidden level between the logical 0 and 1, may propagate and make the matter worse.

Circuitry 1200 can include D flip flop 1204 having an input coupled to receive input signal 1201 from a port (e.g., one of ports 601), and output 1206 that stores the previous state of D flip flop 1204 and is provided to an input of D flip flop 1214. D flip flop 1214 is in series with D flip flop 1204. Circuitry 1200 can also include XOR gate 1205 having a first input coupled to the input signal 1201, a second input coupled to output signal 1206, and output 1202 coupled to a first input of AND gate 1210. Output 1202 of XOR gate 1205 is also the Pin_K_Toggle_ON signal. XOR gate 1205 compares input signal 1201 with output signal 1206 and toggles output 1202 depending on the state signals 1201, 1206 and toggles of clock input received from the output of AND gate 1210. Circuitry 1200 further includes D flip flop 1214 that receives output 1206 as its input and provides output 1215, which indicates a state of the Pin_K. D flip flop 1214 receives clock input from clock signal 1220. Clock signal 1220 is also coupled to a second input of AND gate 1210.

The series arrangement flop flops 1204, 1214, coupled with the use of the same clock signal 1220 effectively mitigate any probability of metastability because the low probability of metastability occurring with flip flop 1204 is multiplied with the low probability of metastability occurring with flip flop 1214. For example, if the probability of creating metastability with a flip flop 1204 is 0.02 over all the phases possible between the transition of 1201 and 1220, the probability of metastability for this topology will be reduced significantly down to about 0.02*0.02=0.0004. In another words, a metastable state that is re-sampled with the same clock in 1214 is much less likely to propagate. Output signal 1202 (i.e., Pin_K_Toggle_On) can be delayed and resampled and used as the wake-up signal for the VPIO circuitry. The second output 1215 (Pin_K_State) of 1200 gives the logic value (“0” or “1”) of the input 1201 with 2 cycles of clock delay at the clock rate of 1220 and is devoid of metastability.

FIG. 13 shows an illustrative low power mode detection circuitry 1300 operative to determine when to cause the VPIO circuitry to rapidly enter into a low power or sleep mode according to an embodiment. The VPIO circuitry and state machines running therein are purposed to convey frames of symbols (symbols represent the state of pins). Upon conveying a frame, an End_of_Frame 1301 is generated. If there is no new IO pin toggle called Any_Pin_Toggle 1302_{1-N} (e.g., outputs of circuitry 700, 750, 800 or 900) to be conveyed over the VPIO circuitry, the state machines and VPIO circuitry enter a low power state using function 1310 (e.g., a NAND gate). NAND gate 1310 creates a “Enter to Low Power” signal 1312 that can be used to enter low power mode. Signal 1312 can also be used to gate OFF the main clock to the VPIO circuitry.

In one embodiment, after an End of Frame has been conveyed on signal 1301, and if no Any_Pin_Toggle 1302_{1-N} is toggled, the “Enter to Low Power” output 1312 may be provided to a processing block. The processing block may include one or several of a timer, a counter, a state machine, and a delay to delay the entering into Low Power mode according to its setting or programming. The processing block may switch off all or a portion of the VPIO system until a next activity is detected or until a predetermined period of time has elapsed.

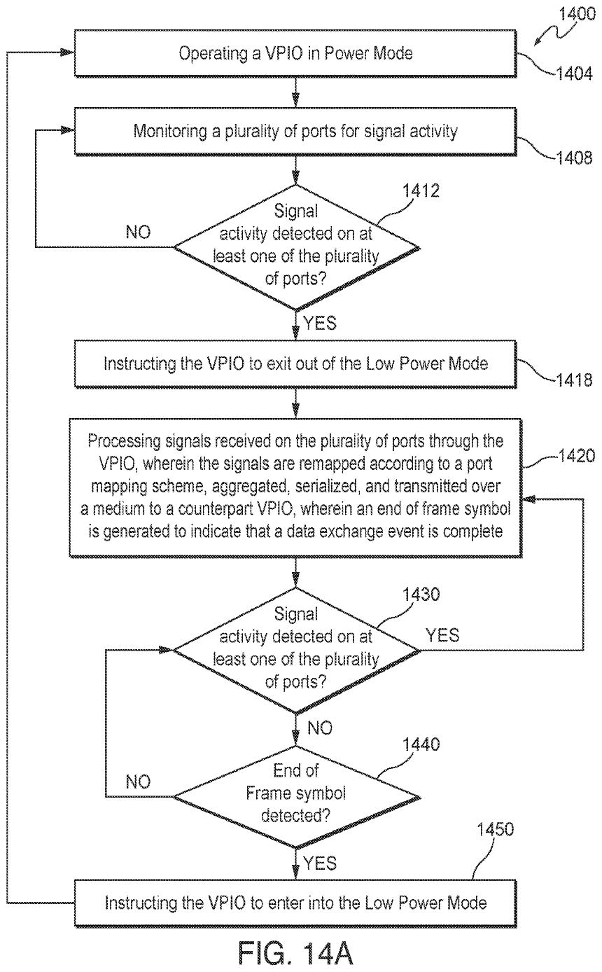

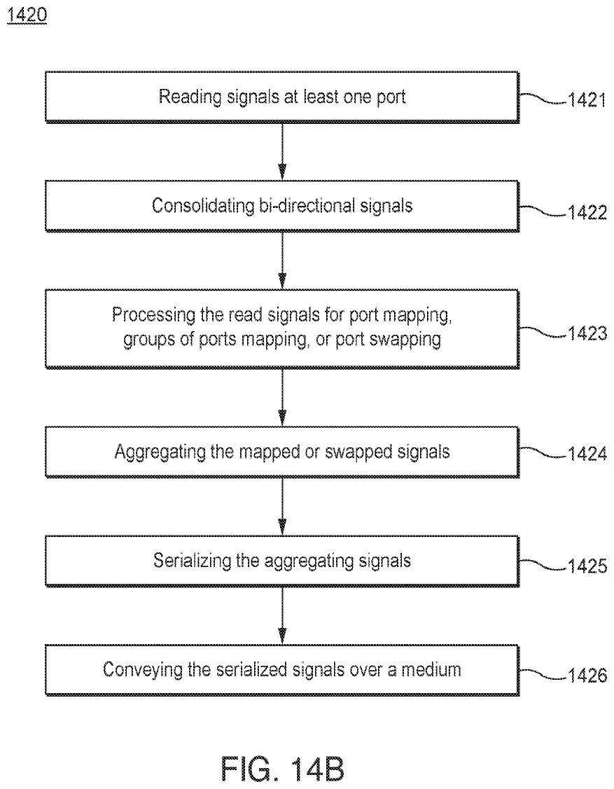

FIG. 14A shows an illustrative process 1400 according to an embodiment. Process 1400 may be implemented in VPIO circuity 600, for example. Moreover, process 1400 discusses exit from low power mode and entry into low power mode when the VPIO is initially operating in a transmitter mode. Starting with step 1404, a VPIO circuitry (e.g., VPIO circuitry 600) is operating in a low power mode. In some embodiments, low power mode requires that no clocks or oscillators be operating. Process 1400 can monitor ports for signal activity at step 1408. For example, port activity detection circuitries 650, 700, 750, 800, 900, 1000, 1100 or 1200 can detect whether any activity is present on any one or more of the ports. Process 1400 can determine whether signal activity is present on at least one of the plurality of ports at step 1412. If no activity is present, process 1400 may revert to step 1408. If signal activity is present on at least one of the ports, process 1400 can instruct the VPIO circuitry to exit out of the low power mode at step 1418. For example, port activity detection circuitry 650 can trigger enabler 640 to activate the necessary clocks, oscillators, processors, state machines, etc. to transition the VPIO to an active mode. Depending on the application in which the VPIO circuitry is used, exit out of low power mode can result in several different active mode scenarios. For example, in one active mode, the VPIO may be fully woken up—in which case, all clocks, processors, state machines, etc. are woken up. As another example, in another active mode, the VPIO circuitry may be partially woken up—in which case, a subset or portion of the clocks, processors, state machines, etc. are woken up.

At step 1420, signals (or data) received on the ports can be processed through the VPIO circuitry. The signals can be remapped according to a port mapping scheme (e.g., as defined by port mapping coordinator 620) and the remapped signals are aggregated, serialized, and transmitted over a medium (e.g., a high-speed bus) to a counterpart VPIO circuitry. An “end of frame” symbol can be generated to indicate that a data transmission event is concluded. In one embodiment, a transceiver can generate the “end of frame” symbol in response to transferring the last signal over the medium. Additional details of specific steps that may be implemented by step 1420 are discussed in connection with FIG. 14B.

Signals may continue to be processed through the VPIO circuitry so long as signal activity exists on at least one of the ports, as determined by step 1430, wherein a YES determination at step 1430 reverts process 1400 to step 1420. If signal activity on the ports has ceased, as determined by step 1430, process 1400 may determine whether an “end of frame” symbol has been detected at step 1440. If the determination at step 1440 is NO, process 1400 reverts to step 1430. If the determination at step 1440 is YES, the VPIO circuitry can be instructed to enter the low power mode at step 1450, and process 1400 can revert to step 1404. For example, low power mode detection circuitry 660 may confirm absence of signal activity on the ports with simultaneous detection of the “end of frame” symbol.

It should be appreciated that the steps shown in FIG. 14A are merely illustrative and that additional steps may be added, the order of the steps may be rearranged, or steps may be omitted.

FIG. 14B shows additional steps that may be taken as part of step 1420 of FIG. 14A according to an embodiment. At step 1421, signals are read from at least one of the ports. Reading of these signals can be performed several different ways. For example, a predetermined condition may need to be satisfied to read the signals, the ports may be read after a delay, the ports may be read after a predetermined processing has been completed, a subset or portion of the ports may be read, all ports may be read, only the ports that that toggled can be read, ports of a certain category (e.g., signal protocol) may be read, ports of multiple categories may be read, a combination of ports associated with one or more categories plus only specifically designated ports may be read. It should be understood that there are numerous other ways known to those with skill in art in which signals can be read off the ports.

In embodiments where bi-directional communications are being utilized by the VPIO circuitry, such bi-directional signals may be consolidated at step 1422. Consolidating step 1422 may be implemented by di-directional consolidation circuitry 603 of FIG. 6. The consolidation of the logic values (states) or sequences of states in Tx direction signals issued from the inputs at 601 and Rx, signals in reverse direction issued from disaggregator 634 can occur according to certain rules, including one or more of the following list to produce a consolidation value per each port 1-N: Connect each of the Tx_N and Rx_N signals together, connect them with a current limitation to avoid excess current when Tx and Rx states are not the same, the binary inputs from both directions are OR-ed together, are AND-ed together, the input signal of the first VPIO circuitry is used (Tx), the input signal of counterpart VPIO circuitry is used (Rx, reverse signal), connect each of the Tx_N and Rx_N signals with an open collector circuitry, connect them with I2C circuitry, each of the Tx_N and Rx_N signals are processed by a combinatory function, by a sequential function, by a processing unit, by a state machine, by a function using a memory; by a function requesting more data from another part of the system, from a user, from a graphical user interface GUI, etc. Also, the way to consolidate the Tx and Rx signals could depend on the type of signals, that is, the consolidation may be done differently if it is a GPIO signal, a I2C signals, etc.

At step 1423, the signals are processed for port mapping, groups of ports mapping, or port swapping. For example, the signal received at port #4, which is associated with a first VPIO circuitry, may need to be mapped to port #34, which is associated with a second VPIO circuitry. Port mapping ensures that the signals are routed to the appropriate port associated with the second VPIO circuitry. For example, port mapping can improve trace routing on the PCB, which can minimize trace lengths, de-tangle any trace connections from the VPIO circuitry to one or more targets. Group port mapping can remap a group of ports (e.g., ports associated with a particular protocol) to more preferred port locations associated with a counterpart VPIO circuitry to optimize trace routing on the PCB. Port swapping can be used to minimize the trace length, match trace lengths, and avoid any crossing of high-speed signals. The signals being processed at step 1423 can include input signals, a portion of the input signals, one or more categories of input signal, high speed serial signals, control signals for the VPIO circuitry, power supply signals for the VPIO circuitry. The various categories of signals can include low speed, medium speed, high speed, GPIO, protocol, I2C, I2S, SPI, USB2, USB3, USB-SS, any USB, DP, SATA, TCP, Wi-Fi baseband, Bluetooth baseband, 3G baseband, 4G baseband, 5G baseband, 6G baseband, UART, JTAG, Ethernet, HDMI, Vx1, next gen Vx1, MIPI DSI, CSI-2, USB3+USB2, MIPI CPHY, USB3.1 gen.2, any generation of PCIE, USB4, Thunderbolt, etc.

At step 1424, the mapped or swapped signals are aggregated and then serialized at step 1425. At step 1426, the serialized signals can be conveyed over a medium to a counterpart VPIO circuitry. The medium can be a high-speed serial bus connecting a pair VPIO circuits. The medium can be one-way or bi-directional. Conveyance of bi-directional signals can be simultaneous or sequential.

It should be appreciated that the steps shown in FIG. 14B are merely illustrative and that additional steps may be added, the order of the steps may be rearranged, or steps may be omitted. For example, step 1422 may be omitted for any or all input signals in 601, FIG. 6, if no bi-directional communications are used on any or all input signals.

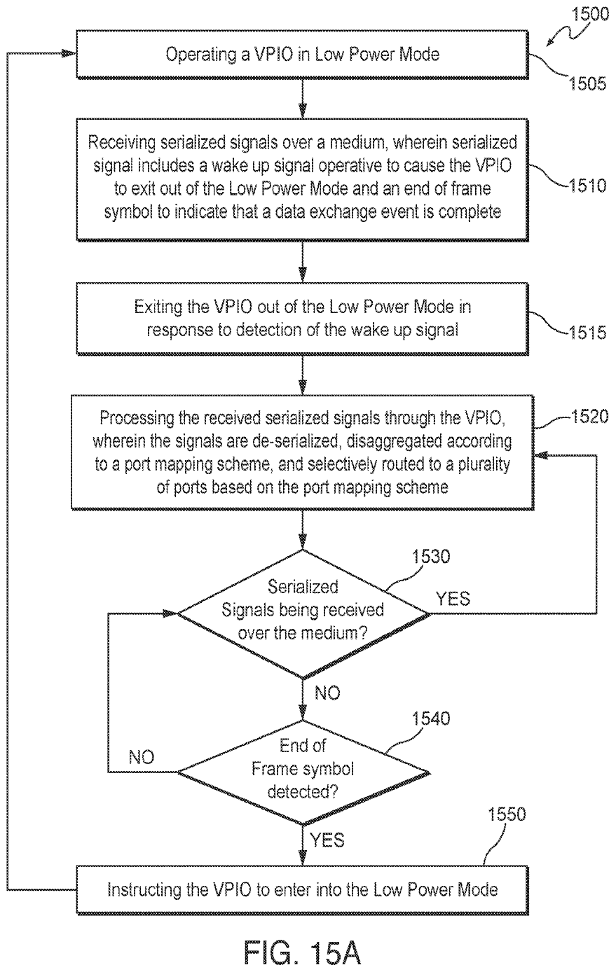

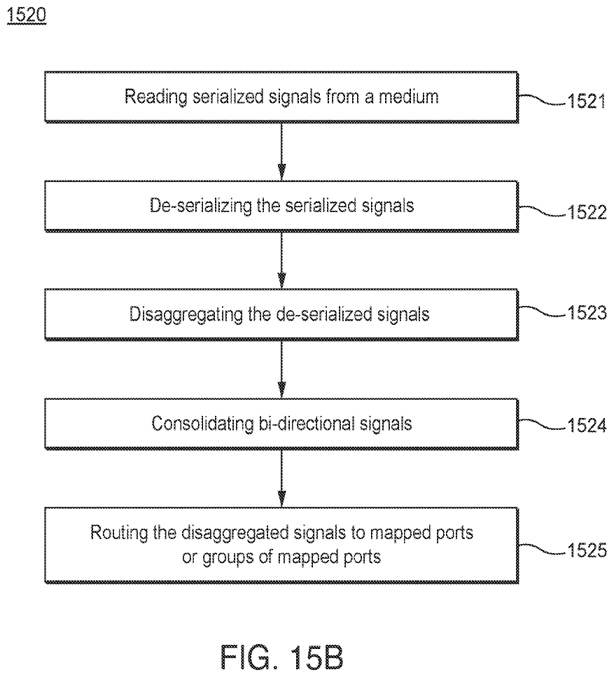

FIG. 15A shows an illustrative process 1500 according to an embodiment. Process 1500 may be implemented in VPIO circuity 600, for example. Moreover, process 1500 discusses exit from low power mode and entry into low power mode when the VPIO circuitry is operating in a receiver mode. If the VPIO circuitry is engaged in bi-directional communications, then both processes 1400 and 1500 may be used. Starting with step 1505, a VPIO circuitry is operating in a low power mode. At step 1510, serialized signals are received over a medium (e.g., a high-speed communications bus). The serialized signals can include a wake-up signal operative to cause the VPIO circuitry to exit out of the low power mode and an end of frame symbol to indicate that a data exchange event is complete. For example, wake up circuitry 699 may detect presence of a wake up signal in the serialized data 695 (or circuitry 699 can detect the wake up signal in de-serialized data).

In another implementation, a detection circuit similar to the port activity detection circuitry 650 can be used on the high-speed serial bus 695 in the wake-up circuitry 699 to detect toggles or changes of states in the data or clock or enable lines. Circuitry such as 700. 750, 800 can detect a toggle with or without the use of an internal clock with the inputs being one or more of the high-speed data, clock and enable line. If several inputs are checked, they can be OR-ed with a circuit such as 1010 and followed by a SR flip-flop 1020 that create a wake-up signal 699 to exit the power mode. The VPIO circuitry can exit out of low power mode in response to detection of the wake up signal, at step 1515.

After the VPIO circuitry exits out the low power state, the received serialized signals can be processed through the VPIO, at step 1520. The signals can de-serialized, disaggregated according to a port mapping scheme, and selectively routed to a plurality of ports based on the port mapping scheme. At step 1530, process 1500 can check whether serialized signals are still being received over the medium. If the determination is YES, process 1500 reverts to step 1520. If the determination is NO, process 1500 can proceed to step 1540, which determines whether the end of frame symbol has been detected. If the determination is NO, process 1500 reverts to step 1530. If the determination is YES, the VPIO circuitry is instructed to enter low power mode at step 1550 and process 1500 reverts to step 1505.

It should be appreciated that the steps shown in FIG. 15A are merely illustrative and that additional steps may be added, the order of the steps may be rearranged, or steps may be omitted.

FIG. 15B shows additional steps that may be taken as part of step 1520 of FIG. 15A according to an embodiment. At step 1521, serialized signals are received from a medium and de-serialized at step 1522. The de-serialized signals can be disaggregated at step 1523. The disaggregation can identify where signals should be routed based on port mapping, groups of port mapping, or port swapping. In some embodiments, port mapping coordinator 620 may be used to make the routing determination. In other embodiments, the routing information is embedded into the signals and is extracted by the disaggregator to determine the routing destination of signals. If bi-directional signals are being used, such signals can be consolidated at step 1524. At step 1525, the disaggregated signals are routed to mapped ports, groups of mapped ports, or swapped ports.

It should be appreciated that the steps shown in FIG. 15B are merely illustrative and that additional steps may be added, the order of the steps may be rearranged, or steps may be omitted.

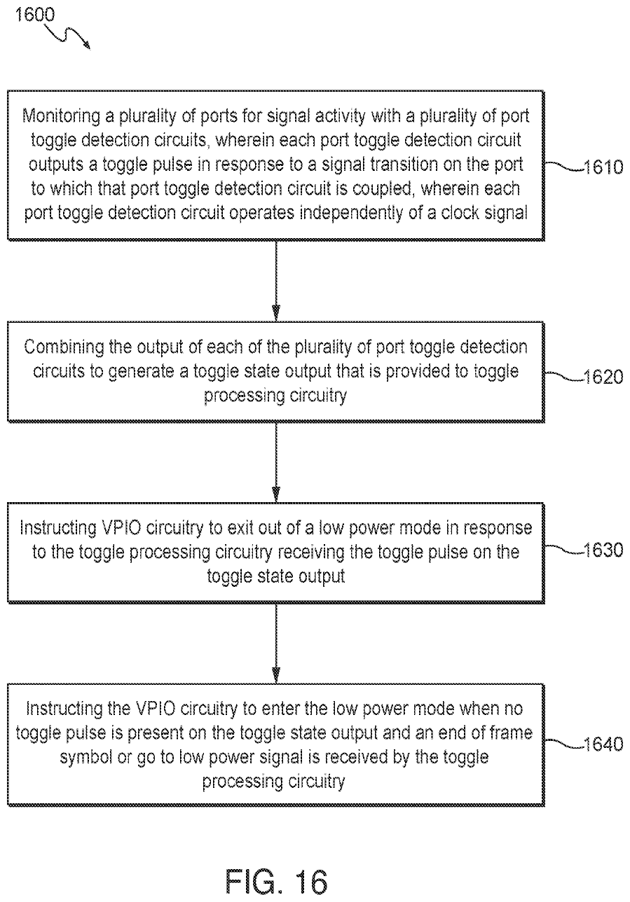

FIG. 16 shows an illustrative process 1600 for exiting out of lower power mode and entering into low power mode according to an embodiment. Process 1600 can be implemented in circuitry 600 of FIG. 6 and in particular may be implemented using circuitry 700, 750, or 800 and circuity 1300. Starting with step 1610, a plurality of ports are monitored for signal activity with a plurality of port toggle detection circuits, wherein each port toggle detection circuit outputs a toggle pulse in response to a signal transition on the port to which that port toggle detection circuit is coupled, wherein each port toggle detection circuit operates independently of a clock signal. The clock signal independence can require that the plurality of port toggle detection circuits are operative to monitor the ports without use of a clock signal supplied externally from the port toggle detection circuits or internally within the port toggle circuits. In some embodiments, the toggle pulse is a 010 transition.

At step 1620, process 1600 can combine the output of each of the plurality of port toggle detection circuits to generate a toggle state output that is provided to toggle processing circuitry. In one embodiment, the toggle processing circuitry includes a RS flip flop (e.g., flip flop 1010), wherein the toggle state output is coupled to a first input of the RS flip flop. At step 1630, process 1600 can instruct VPIO circuitry to exit out of a low power mode in response to the toggle processing circuitry receiving the toggle pulse on the toggle state output. The VPIO circuitry can then process signals as described herein before returning to the low power state. At step 1640, the VPIO circuitry may be instructed to enter the low power state when no toggle pulse is present on the toggle state output and an end of frame symbol or go to low power signal is received by the toggle processing circuitry. For example, assuming that the toggle processing circuitry is a RS flip flop, a first input can be connected to the toggle state output and a second input can be coupled to receive a signal from a low power detection circuit (e.g., circuit 1300) or coupled to monitor data lines (e.g., serialized data link or de-serialized data link) for an end of frame symbol. When the toggle signal goes low and the second input goes high, then the flip flop may instruct the VPIO circuitry to enter the low power mode.

It should be appreciated that the steps shown in FIG. 16 are merely illustrative and that additional steps may be added, the order of the steps may be rearranged, or steps may be omitted.

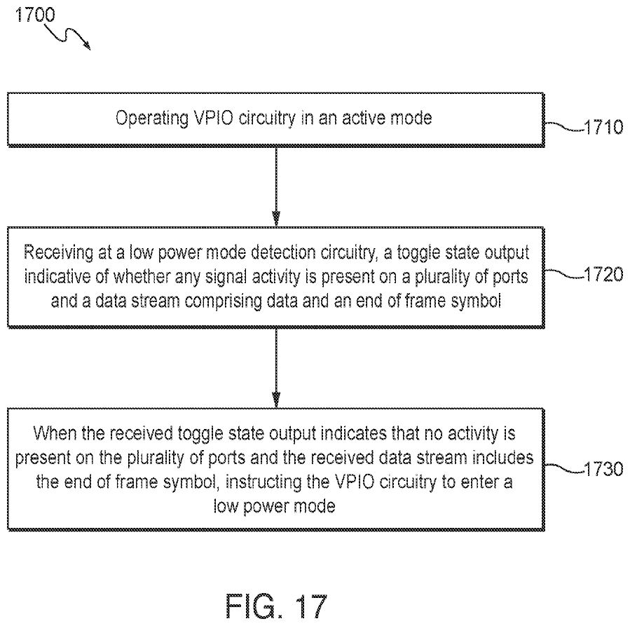

FIG. 17 shows an illustrative process 1700 for determining when to enter low power mode according to an embodiment. Process 1700 may be implemented, for example, by circuitry 660 or circuitry 1300. VPIO circuitry may be operating in an active mode at step 1710. Low power mode detection circuitry can receive a toggle state output indicative of whether any signal activity is present on a plurality of ports and a data stream comprising data and an end of frame symbol, at step 1720. For example, the toggle state output can be provided by port activity detection circuitry 700, 750 or 800. The data stream can be sourced from serial data stream being transmitted to another VPIO circuit (e.g., high speed transmit bus 693) or can be sourced from a serial data stream received from another VPIO circuit (e.g., via high speed receive bus 695). In some embodiments, the data stream can include both the transmitted serial data and the received serial data. If data is being received from a counterpart VPIO circuit, the VPIO circuit can process that received data and route the data to the appropriate ports. Thus, these ports will show activity that is detected by port activity detection circuitry that provides the toggle state output.

When the received toggle state output indicates that no activity is present on the plurality of ports and the received data stream includes the end of frame symbol, the VPIO circuitry can be instructed to enter a low power mode, at step 1730.

It should be appreciated that the steps shown in FIG. 17 are merely illustrative and that additional steps may be added, the order of the steps may be rearranged, or steps may be omitted.

Port mapping according to embodiments discussed herein enable a signal being received one at a particular port associated with first VPIO circuitry to be routed to any port associated with second VPIO circuitry. For example, consider a device having a pair of VPIO circuits, one located on a first board and another located on a second board. The pair of VPIO circuits may be configured to have a different port for the same signal. The first VPIO circuit may have the signal GPIO_27 routed thereto from port C14. After aggregation (by the first VPIO circuit), conveyance via a high-speed serial link, and disaggregation (by the second VPIO circuit), a copy of the signal GPIO_27 can be routed to port A3. Port mapping can also enable a group of signals received on a first group of ports to be mapped to a second group of ports. For example, a first group of signals (e.g., such as signals for accommodating a display port protocol) received by the first VPIO circuitry can be routed to a group of ports (e.g., ports that designated to carry the display port protocol) associated with the second VPIO. Port mapping can enable simpler trace routing on a printed circuit board with minimum crossing and intertwined traces and a reduction in the average trace length for signals being conveyed from one VPIO to another. Port mapping also enables optimization of trace routing on printed circuit boards because signals can be remapped to ports best positioned to take advantage of optimal trace routing.

Port mapping may be managed by a port mapping coordinator according to some embodiments. The port mapping coordinator may permanently configure or dynamically reconfigure a port mapping scheme for a pair of VPIO circuits or multiple pairs of VPIO circuits. The port mapping coordinator may include an internal register, firmware, memory, or some other mechanism for implementing a port mapping scheme. In some embodiments, the port mapping scheme can be hard coded, dynamically programmed, or statically programmed. A permanently programmed port mapping scheme may be used in embodiments that have a fixed protocol/port configuration such as in a board to board connection configuration. A dynamically programmed port mapping scheme may be used in embodiments that have a variable protocol/port configurations such as device to device connections. For example, a host device may be capable of supporting many different protocols over a fixed set of ports, but a peripheral device attached thereto may only be able to support a limited set of protocols. The host device may need to reconfigure its port mapping scheme to accommodate the peripheral device. Various embodiments for implementing a port mapping scheme are now discussed.

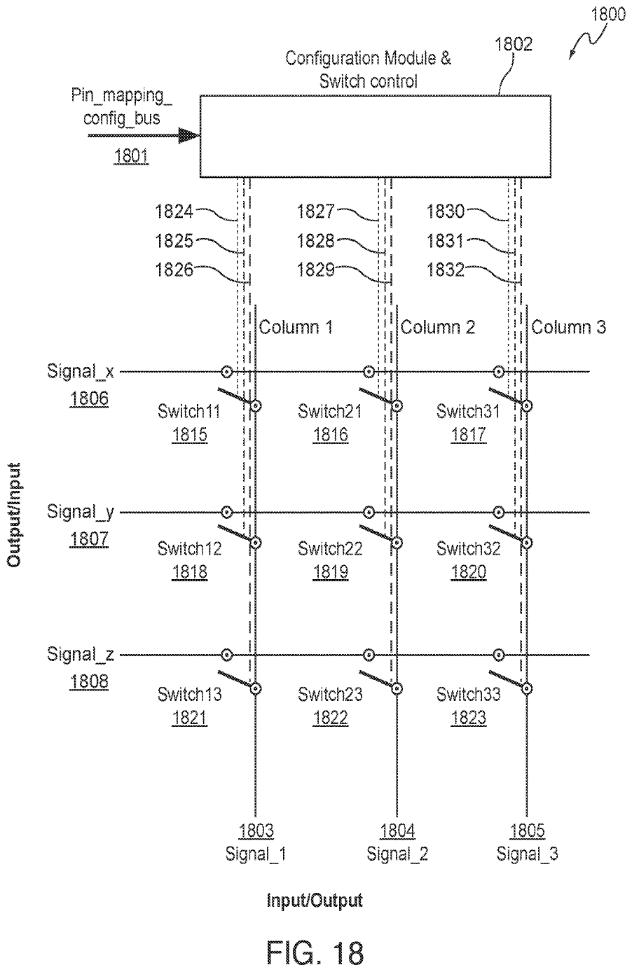

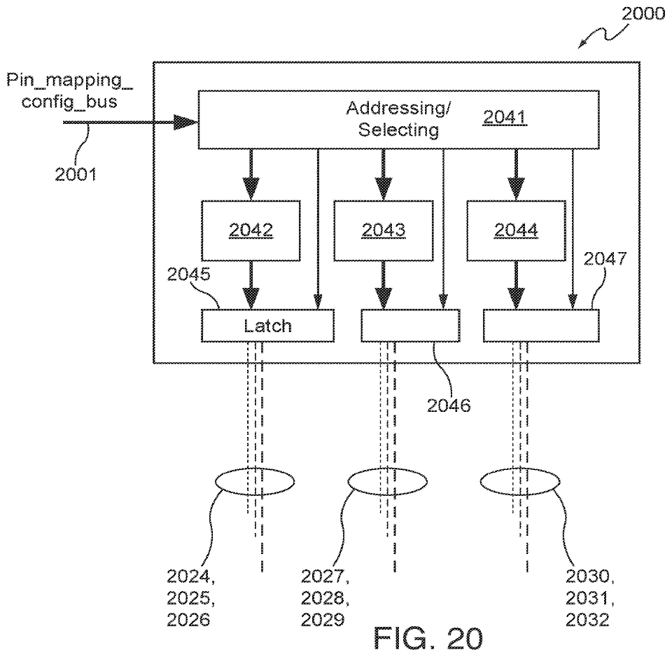

Referring briefly to FIG. 6A, port mapping can be accomplished using aggregator 612 in conjunction with port mapping coordinator 620. Not shown in FIG. 6A is a switch matrix that can be controlled by a switch control module (also not shown in FIG. 6A). A switch matrix can be a matrix of switches that connect any one of I inputs to any one of I outputs. Example of such a switch matrix is shown and discussed in connection with FIG. 18. The switch control module can configure how the switch matrix connects each of its I inputs to respective ones of its I outputs. Port mapping coordinator 620 may include such a switch control module, many different embodiments of which are discussed in connection with FIGS. 20-22. The switch matrix may be included as part of aggregator 612 or can be a separate component that is positioned upstream of aggregator 612. In operation, the switch matrix can receive each of ports 601 or a subset thereof as inputs (or source ports) and connect the inputs to outputs. The outputs can represent the new port position or destination port—the remapped port—as specified by port mapping coordinator 620. The outputs of the switch matrix are provided to aggregator 612, which processes any signals being routed through the switch matrix in accordance with the port mapping scheme set by port mapping coordinator 620 for conveyance to a counterpart VPIO circuit. In some embodiments, aggregator 612 can in combination with encoder 614 generate a message or packet that includes data and an address of the destination or remapped port that is provided to transceiver 690 for conveyance to the counterpart VPIO circuit. This message is received by the counterpart VPIO circuit, decoded, disaggregated, and the data contained in the message routed to the destination port specified by the address. In FIG. 6A, the message is received via bus 695, de-serialized by de-serializer 694, decoded by decoder 632, and parsed by disaggregator 634. There is no re-mapping, per se, by receive side of VPIO circuit 600 because the signal was mapped during by the transmit side of VPIO circuit 600. In some embodiments, the receive side can access or use port mapping coordinator 620 as a lookup table to determine where a received message should be routed.

In some embodiments, the mapping can reside in the receive path and be processed in the decoder circuitry 632, in the de-aggregator 634, or partly in both. In another embodiment, the mapping can be processed in the transmitter aggregator, or in the receive de-aggregator. In yet other embodiment, the mapping can be implemented within VPIO circuitry, within the VPE, or within the aggregator-disaggregator module, or externally to VPIO circuitry, the VPE, or the aggregator-disaggregator module. In yet another embodiment, the mapping can be located in the VPIO transmit path and in the receiver path of the counterpart VPIO circuitry. In yet another embodiment, the mapping can be located in the aggregator transmit path (e.g., the aggregator) and in the receiver path of the counterpart circuitry (e.g., the disaggregator).

In some embodiments, the mapping function can be incorporated in an existing solution in conjunction with an aggregator or disaggregator, or both, in firmware, software, micro-code or hardware, for instance in an existing processing unit, a micro-controller, a FPGA or an ASIC.

FIG. 18 shows an illustrative switch matrix 1800 that can map any signal received on a source port to any destination port according to an embodiment. Switch matrix 1800 is a 3×3 matrix that can used for mapping any input signal_1 1803, signal_2 1804 and signal_3 1805 to one of ports 1806, 1807, and 1808. This is a simple example with 3 signals and 3 ports but the number of ports can reach any high number of ports as determined by the application, the package size, the ball/pin pitch. In some embodiments, switch matrix 1800 can be expanded to be matrix of I×I, with I being a positive integer of minimum value of 1, thereby enabling I signals to be remapped to any of the I ports. By default, all 9 switches_11 1815 to switches_33 1823 are open and make no connection. Any switch is closed to form a connection only for the purpose of a signal to be connected to a port.

Using configuration module and switch control 1802, a pin_mapping_config_bus (serial or parallel) of multiple logic signal bits can activate one of switch11 1815, switch12 1818, and switch13 1821 to connect Signal_1 1803 to one of outputs 1806, 1807, and 1808 using control lines 1824-1826. Switch control 1802 can activate one of switch 21 1816, switch 22 1819, and switch23 1822 to connect Signal_2 1804 to one of outputs 1806, 1807, and 1808 using control lines 1827-1820. Switch control 1802 can activated one switch31 1817, swtich32 1820, and swtich33 1823 to connect Signal_3 1805 to one of outputs 1806, 1807, and 1808 using control lines 1830-1832. To ensure proper operation, switch matrix 1802 couples each signal to only one output port. For example, signal_1 1803 can be connected to port 1808, signal_2 1804 to port 1806, and signal_3 1805 to port 1807. As another example, signal_1 1803 can be connected port 1806, signal_2 1804 to port 1807, and signal_3 1805 to port 1808.

Switch matrix 1800 can be used in connection with a VPIO circuitry, and in particular, can be implemented in a port mapping coordinator. Bi-directional switches 1815-1823 can enable a signal to be routed in both directions, for instance from the inputs 1803, 1804, and 1805 to outputs 1806, 1807, and 1808 or vice and versa from outputs 1806, 1807, 1808 to inputs 1803, 1804, 1805. Thus, for bi-directional communications, switch matrix 1800 may be used sequentially to enable communications in a first direction and then in a second direction. This scheme can be used for slow-medium speed signals and improve complexity, size and static power consumption.

For most implementations, the connectivity from signals to ports are determined by the routing on a printed circuit board. Therefore, the connection of switch matrix 1800 can be permanently set in the same configuration for a relatively long retention time. During this retention time, no clock change nor change of state is needed to maintain the switches in their configuration. This can be an important factor for enabling low power VPIO circuits where clock transitions or clock frequency adversely affect power consumption.

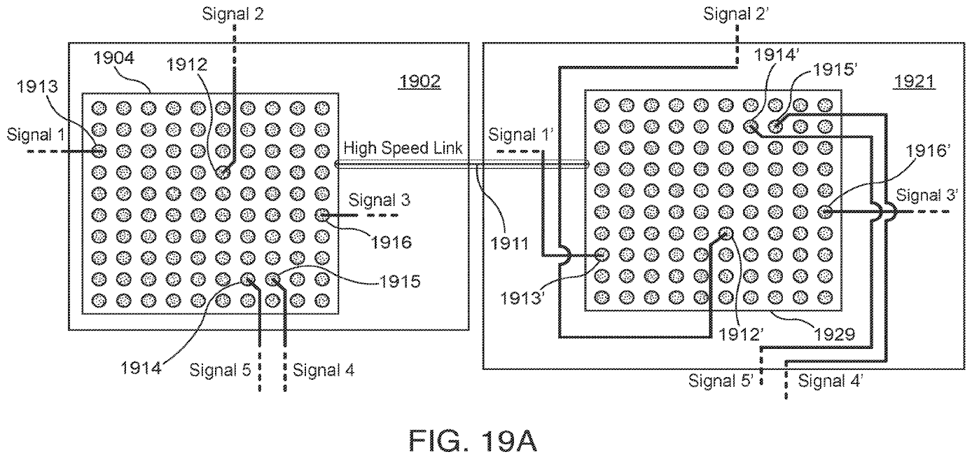

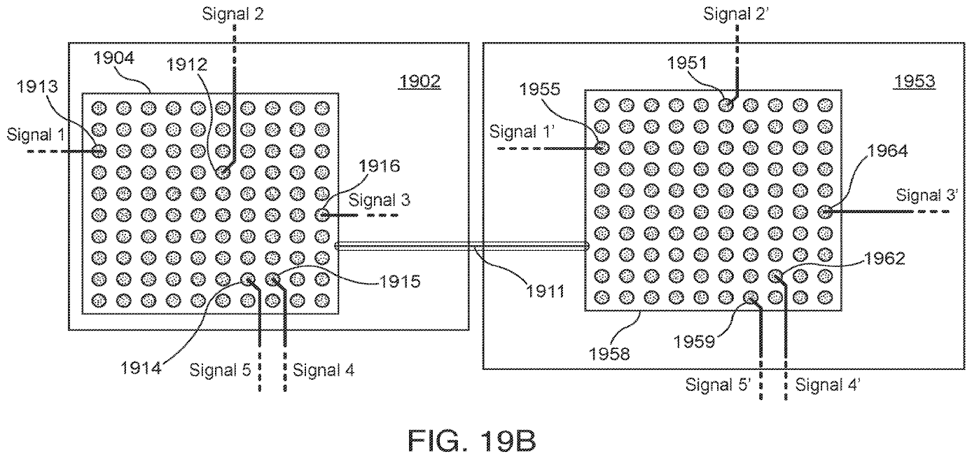

FIGS. 19A and 19B contrast trace routing of a pair of VPIO ICs without and with use of port mapping. FIG. 19A shows VPIO IC 1904 and VPIO IC 1929 and their respective traces without use of port mapping. FIG. 19B shows VPIO IC 1904 and VPIO IC 1958 and their respective traces with use of port mapping. Referring now to FIG. 19A, Board 1902 shows the trace layout with respect to VPIO IC 1904. Board 1921 shows the trace layout with respect to VPIO IC 1929. Five input signals Signal-1 to Signal-5, associated with VPIO IC 1904, are aggregated and conveyed to VPIO IC 1929 via high-speed link 1911. Signals Signal-1′ to Signal-5′ are connected to the respective ports 1913′, 1912′, 1916′, 1915′and 1914′. Note that the traces stemming from Signals 1′-5′ are not compact or efficiently routed. This may be because no port mapping is used and Signals 1′ to 5′ follow the same port geometry used by board 1902. In contrast, in FIG. 19B, board 1953, the traces stemming from Signals 1′ -5′ to their respective ports have minimal length and no entanglement.

Moreover, considering modern electronic design, the IC tends to be small and with a fine ball pitch (e.g., 0.25 mm). This causes routing to any balls and particularly any inside balls challenging. Printed circuit boards with multi-layers may also be used, which further complicate routing and increases cost. Another constraint is that the traces of high serial link 1911 are typically optimized for minimum length, no or minimum trace crossing, and having a controlled line impedance. Given these constraints, it is difficult to have traces crossing inside of the package of VPIO IC 1904 and package of VPIO IC 1929 in both vertical and horizontal directions. Board 1921 shows trace complication and crossings required to connect ports 1912′-1916′ to their respective targets (Signals S1′-S5′). Given placement requirements and optimization, VPIO IC 1929 may be placed in any horizontal direction 0, 90, 180, 270 degrees on the same PCB as VPIO IC 1904 or flipped 180 degrees if on the other PCB side, or may be flipped 0 or 180 degrees and rotated any direction 0, 90, 180, 270 degrees if placed on a different PCB versus VPIO IC 1904. Note that the example illustrated FIG. 19A, only 5 input signals are used and the resulting trace connections on VPIO IC 1929 are not optimal. Such routing would become increasingly problematic when more signals (e.g., 50 or 100) are used.

Referring now FIG. 19B, trace routing for VPIO IC 1958 is significantly simplified with respect to VPIO IC 1929. Signals 1′-5′ have been remapped to ports that optimize the routing. Specifically, Signal 1′ is mapped to port 1955, Signal 2′ is mapped to port 1951, Signal 3′ is mapped to port 1964, Signal 4′ is mapped to port 1962, and Signal 5′ is mapped to port 1959. One skilled in the art can appreciate that as the number of signals being used increases, the remapping scheme according to embodiments discussed herein enables easier routing, potentially less PCB layers, shorter traces distances, and a reduction of entanglements.

FIG. 20 shows an illustrative configuration module and switch control 2000 that can be used to control a switch matrix to implement a port mapping scheme according to an embodiment. Switch control 2000 can include addressing/selecting block 2041, demultiplexers 2042, 2043, and 2044, and latches 2045, 2046, and 2047. Pin_mapping_config_bus 2001 can carry signals that control addressing and selecting block 2041. Latch 2045 is connected to control lines 2024 to 2026, latch 2046 is connected to control lines 2027 to 2029, and latch 2047 is connected to control lines 2030 to 2032. Each control line controls one switch. In this example, since 9 control lines exist, the switch matrix includes 9 switches. Accordingly, three signals can be mapped to three ports using a switch matrix of 3×3 switches. Nine switch control lines 2024 to 2032, and 3 latches each having 3 outputs are also used. This implementation is appropriate for a small-medium number of ports requiring port mapping. However, if a high number of ports, such as 50 ports, require mapping, switch control 2000 would requires fifty (50) latches each having 50 inputs and 50 outputs, three demultiplexers each having 50 bit outputs and a minimum of 6 binary coded input bits, and addressing block 2041 would require 18 bits minimum in outputs and inputs.

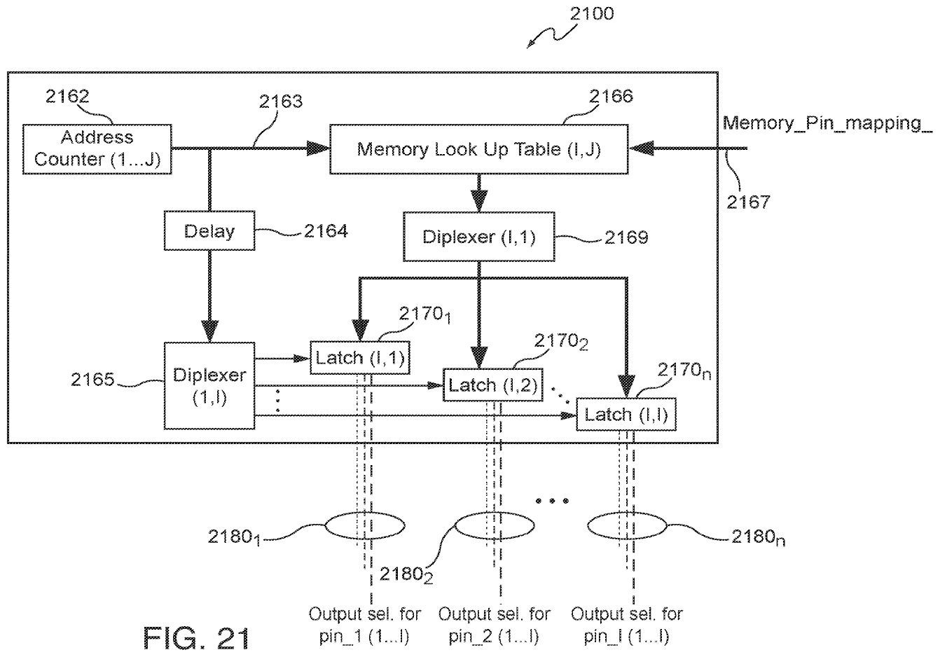

FIG. 21 shows an illustrative configuration module and switch control 2100 that can be used to control a switch matrix to implement a port mapping scheme according to an embodiment. Switch control 2100 may be suited for enabling a port mapping scheme for a medium to high number of signals and ports. Switch control 2100 can include address counter 2162, delay block 2164, diplexer 2165, memory 2166, diplexer 2169, latches 2170₁-2170ₙ, and switch selection lines 2180_{1(1 . . . n)} through 2180_{n(1 . . . n)}. Memory 2166 may be programmed once per retention period via memory_program 2167. If memory 2166 can retain its memory without any retention voltage such as an EEPROM it can be written only once for its life duration, for example, during manufacturing.

For I signals and I ports to map, a I×I switch matrix, I×I switches, and I'I switch selection lines 2180_{1(1 . . . n)} through 2180_{n(1 . . . n)} are needed, in addition to I latches of I outputs and I inputs. In this particular implementation, only one diplexer 2169 of I outputs and a minimum of ceil(log2(I)) inputs and a memory 2166 of I*I size with a minimum of 2*ceil(log2(I)) inputs are needed as each output of ceil(log2(I)) symbols defines one single signal to map on a port. Address counter 2162 of J=2*ceil(log2(I)) outputs 2163 and an optional delay block 2164 of J inputs and J output bits to match the delay in the path a) from address counter 2162 to diplexer 2165, versus the path b) from address counter 2162 to memory 2166, diplexer 2169 and latches 2170₁-2170ₙ, and any output from latches 2170₁-2170ₙ.

Address counter 2162 scans memory 2166 for each of the J symbol of I length and the corresponding latches 2170₁-2170ₙ, is latched synchronously and sequentially at each new J address. Therefore, the latch 2170₁ is latched for the address J=1, latch 2170₂ for J=2, and the last latch 2170ₙ with J=I. Assume for an example that the number of signals to map to ports is 60. The switch matrix is 60*60 and includes 60*60 switches and 60*60 control lines. Further, there are 60 latches each having 60 output, diplexer 2169 has 60 outputs and ceil(log2(60))=6-bits input. Memory 2166 has 6 bits output and 2*6=12 bits inputs at 2163. Address counter 2162 has 12 bits of outputs and diplexer 2165 has 12 bits of inputs and 60 outputs. Switch control 2100 can sequentially set all the switch control lines, which takes about I clocks of the address counter 2162 to set the switch matrix connections. If the clock is 10 MHz, and there are 60 ports to map, it takes about 6 us for the 60 signals to be mapped to the 60 ports once per memory retention voltage cycle.

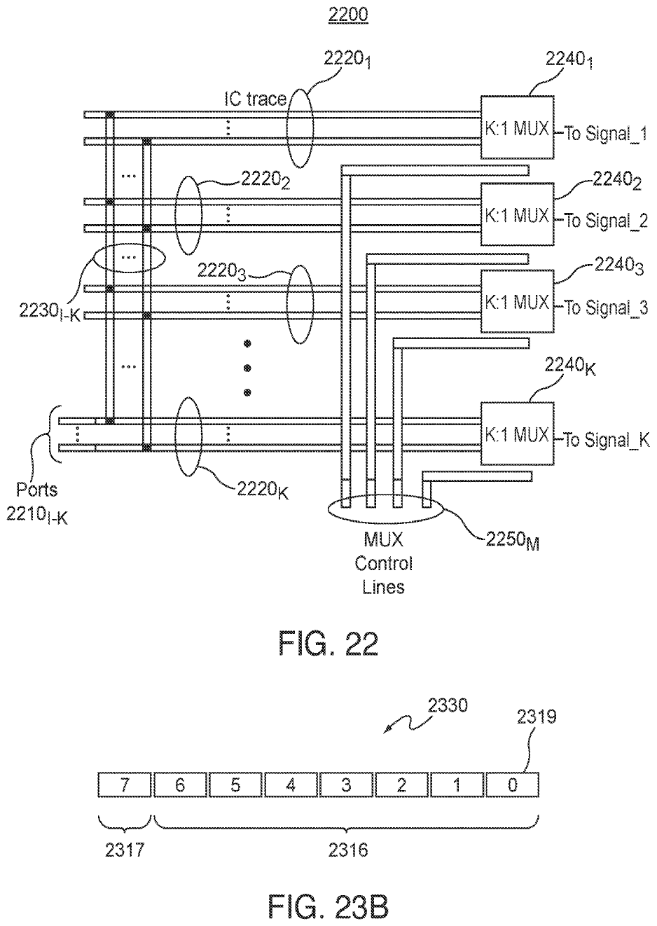

FIG. 22 shows an illustrative signal routing configuration module 2200 that can be used to route source ports to destination ports to implement a port mapping scheme according to an embodiment. Signal routing configuration module 2200 may be suited for enabling a port mapping scheme for a high number of signals and ports. Configuration module 2200 does not require a switch matrix. Signal control 2200 can connect K Ports 2210_{1-K} to K Signals_{1-K}. Ports 2210_{1-K} are connected to trace group 2220_{1-K}, which are connected to multiplexers 2240_{1-K}. Multiplexor 2240_{K} is connected to Signal_{K} and is controlled by MUX control lines 2250_{M}. MUX control lines 2250_{M} determines which one of ports 2210_{1-K} is connected to Signal_{K} by multiplexer 2240_{K}.

Configuration module 2200 include K multiplexers 2240_{1-K}. Each multiplexor 2240_{1-K} is connected to all the traces from ports 2210_{1-K}. For example, if there are 70 ports, 70 traces exist, and all of 70 traces are connected to each of the 70 multiplexers. Transverse lines 2230_{1-K} are connected to each of trace groups 2220_{1-K}. If there are 70 ports 1-K, 70 transvers lines 2230_{1-K} are required. Multiplexers 2240_{1-K} are controlled by respective MUX control lines 2250_{M}. If there are 70 multiplexers, there may be up to 70*70 MUX control lines. Each Mux control line may include multi-bit signal capability. The number of control lines per multiplexer depends on whether digital coding is used on these lines. MUX control lines 2250_{M} can be generated by a logic block such as switch control 2000 or switch control 2100.

If no digital coding is used for control lines 2250_{M}, and the K multiplexer can be loaded simultaneously, K controls lines per multiplexer are needed and a total of M=K*K control lines are required for all multiplexers 2240_{1-K}. As an example, if there are 70 signals and 70 ports, the number of Mux control lines may be 70*70=4900 traces.

In another implementation, if digital coding is used for the control lines 2250_{M} to control K multiplexers independently, ceil(log2(K)) of binary coded bits are needed for addressing 1 multiplexer or K*ceil(log2(K)) binary coded bits for all K multiplexers. This assumes each multiplexer includes a binary decoder to decode the control lines and converting the ceil(log2(K)) binary coded bits of K demultiplexed control lines to activate one of the K multiplexer switches. This also assumes a 1-bit register that maintains the signal to port selected/mapped. A total of K*ceil(log 2(K)) 1-bit registers with retention are needed. With the same example of 70 signals and ports to multiplex, a total of 70*ceil(log2(70))=490 traces are required. Additionally, each multiplexer has 7 1-bit registers for a total of 490 1-bit registers for all multiplexers.

In yet another implementation, the selection of signals to ports can be performed sequentially one multiplexer at a time. The same MUX control line bus 2250_{M} of K bits can be shared between all the multiplexers but an enable port per multiplexer determines which multiplexer is selected. The total number of MUX control lines and enable wires would be M=K+K=2K. This implementation also requires that each multiplexer includes K+1 1-bit registers that maintain the signal to port mapping. A total of K*(K+1) registers with retention are needed. With the same example of 70 signals and ports to multiplex (to map), 2*70=140 traces 2250_{M} would be required. Additionally, 70*(70+1)=4970 1-bit registers are needed for all multiplexers with a sequential loading.

In yet another implementation of sequential selection of the multiplexers, each multiplexer is controlled by a binary coded bus 2250_{M} with ceil(log2(K)) mux control lines shared amongst all MUXes and 1 enable per mux or 70 enable for all the MUXes. The enable bus of K enable lines can also be binary coded to reduce the number of coded enable wires down to ceil(log2(K)) for a total of 2*ceil(log2(K)) lines per multiplexer in 2250_{M}. Additionally, 2*ceil(log2(K)) 1-bit registers per mux is needed for a total of 2K*ceil(log2(K)) 1-bit registers. Using the same example of 70 signals and 70 ports, 2*ceil(log2(70))=14 MUX control lines and 14 1-bit reg per MUX are needed and 2*70*ceil(log2(70))=980 1-bit registers total. One advantage of this implementation is the low number of mux control line traces 2250_{M} shared between every multiplexer 2240_{1-K}. However, each mux requires a double 7-bits address decoder for the mux control lines in the example of 70 signals and 70 ports.

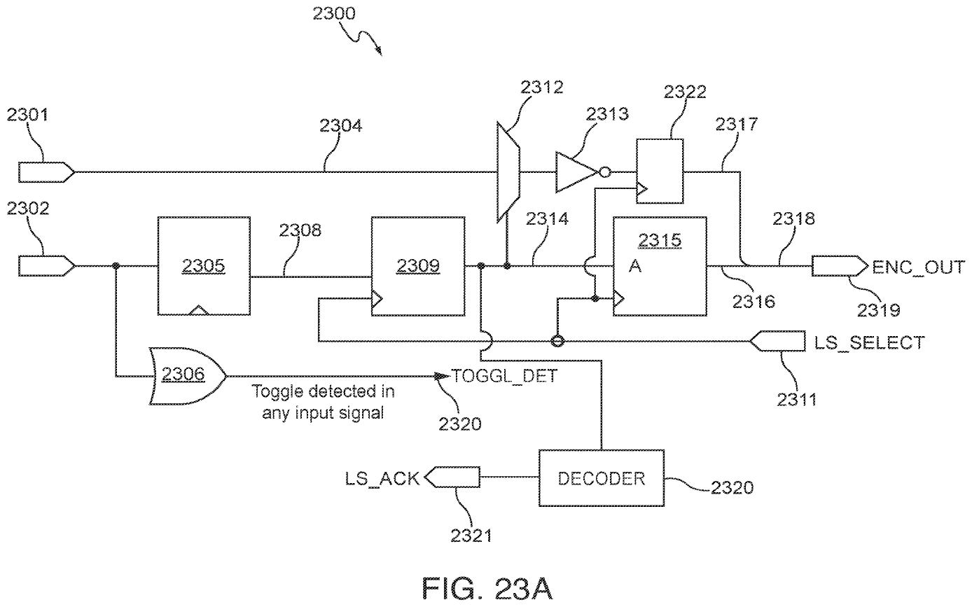

FIG. 23A shows illustrative port mapping circuit 2300 for implementing a port mapping scheme according to an embodiment. Circuit 2300 can be used for applications with low or medium speed signals. Port mapping circuit 2300 is a switchless design that may be used in lieu of a switch matrix and a corresponding switch control module. Port mapping circuit 2300 can include signals 2301 that represent a collection of (low speed) digital port signals being carried by bus 2304 to multiplexer 2312. The output of multiplexer 2312 is coupled to an inverter 2313. Inverter 2313 may be included to output the true port state, which is the inverse of the input port while the GPIO circuit is indicating a port change. An output of inverter 2313 is connected to D flip flop 2322 to correct the pipeline with lookup table (LUT) 2315. The output of the D flip flop 2322 is concatenated to bus 2316, to create a concatenated bus 2318 which is connected to output 2319, which may be connected to a VPIO Scheduler. Port mapping circuit 2300 can also include LS_TOGGLE signals 2302 that indicate whether each port has changed. Signals 2302 are provided to a priority encoder 2305 and OR gate 2306. LS_TOGGLE signals 2302 include toggles (e.g., state transitions) of LS_VAL signals 2301. The output value 2316 of encoder 2305 is a representation of the number of a single port toggle. The outputs of encoder 2305 are connected to an input of flip flop 2309, which has an output coupled to the signal select input of multiplexer 2312 and the input of memory look up table 2315 and decoder 2320. The output of look up table 2315 is concatenated with the output of flip flop 2322 onto bus 2318. Clock signal from the VPIO scheduler, LS_SELECT 2311 coupled to clock inputs of look up table 2315, flip flop 2322, and flip flop 2309. The output of OR gate 2306 is provided to as a toggle detection signal TOGGLE_DET 2320 that is used to indicate that port information is ready to be communicated.

Bus 2318 is the concatenation of the symbol output (2316) by look up table 2315 and an output bit (2317) provided by flip flop 2322. The concatenated result exits circuitry 2300 as an encoded output ENC_OUT 2319. ENC_OUT 2319 can include a byte represented by message 2330 in FIG. 23B. The look up table portion of message 2330 (address of toggled port I) can occupy bit positions 0-6 and the inverter bit can occupy bit position 7 (value of the previous toggled state port I).

The toggle signals from port 1-I 2302 are encoded in encoder 2305 such that N toggle addresses are generated. As an example, 80 signals can be encoded in ceil(log2(80))=7 bits. This address 2308 is fed into a flip flop 2309, which is clocked by LS_SELECT 2311.

When clocked, the output 2314 selects a value on bus 2304 with the multiplexer 2312. The address 2314 also feeds into memory look up table 2315, which outputs a port allocated for the input port signal I (received on toggle signals 2302) to the counterpart VPIO circuitry. The byte encoded in ENC_OUT 1019 contains the last transition value of a particular input port signal I and the address of the toggled port value I. The companion VPIO circuitry, upon receiving the encoded output, can route the signal to the remapped port.

If several toggles 2302 are detected in input signals 2301, port mapping circuit 2300 may transmit each encoded message sequentially. For example, if the entirety of 128 low speed GPIO input signals 2301 over 128 ports change state (toggle) simultaneously at the rate of 32 KHz each, this can generate an equivalent high speed serial data rate of 128*32 KHz*8 bits/byte≈32.8 Mbps to process all the messages output on ENC_OUT 2319. On average and depending on the traffic capacity, a fraction of the I ports may change states over its totality of the I input ports. Continuing with the same previous example of 128 input ports, a low traffic condition may trigger a subset of the 128 ports (e.g., 11 ports). With high traffic the number of toggles during a cycle may be 47. With heavy traffic this number may be 102.

In one embodiment, input 2301 and/or input 2302 may be latched. In another embodiment, the outputs 2319 and 2321 may be latched. Port mapping circuit 2300 sequentially processes all the inputs that toggled, and adding latches to the input, output or both may prevent latency difference between the inputs, outputs, or both. In yet another implementation, a flag can be sent to communicate that the encoded output is synchronous.

In one implementation, the VPIO or aggregation module can provide one or more layers of mapping, called frame mapping. Using frame mapping, the input ports may be processed according to attributes of the ports (e.g., protocol, speed, port location, etc.). For example, the inputs 2301 and 2032 in FIG. 23A, ports 2210_{1-K} in FIG. 22, or outputs/inputs 1806-1808 in FIG. 18 may be aggregated, encoded, serialized, and sent in one or more frame(s) based on the attributes of the ports. Frame mapping can prioritize signals by high data rate and low latency, and process slower signals at a slower rate. Frame mapping may be created in the aggregator or VPIO and selected by the aggregation/VPIO table. The order and the number of times in which the input signals are read and reconstructed in the counterpart aggregator solution effectively creates a mapping, resulting in any desired port mapping, group of port mapping or port swapping. For example, in one embodiment, assume all ports are associated with a high speed protocol. In this embodiment, all the input ports associated with the high speed fast protocol may be sent in each frame. As another example, assume the ports include a mixture of slow, mid, and high speed protocols. In this example, the ports associated with the mid speed and high speed protocols can be sent each frame, but the ports associated with the slow speed protocol can be sent once every X number of frames, where X is an integer greater than 2. In yet another example, high speed ports may be sent several times in each frame. Thus, it should be appreciated that the possible combinations of port mapping are limitless using frame mapping.

In some embodiments, a VPIO port mapping table can be contained in VPE 426 (of FIG. 4) or the one in VPE 432 (of FIG. 4) and may be manipulated to provide port mapping, port group mapping or port swapping. In another words, the VPIO port mapping table can be changed, if desired, to enable a different mapping between the signal ports associated with a first VPIO IC and signal ports associated with a second VPIO IC. For example, if there are four ports being provided to a transmitter VPIO IC, the VPIO port mapping table can change of order those four ports to 1, 4, 3, 2 to cause signals to be routed to another port on the receive VPIO IC. The VPIO table can be manipulated or enforced by the transmitter VPIO IC or the receiver VPIO IC.

In some embodiments, a device may use a switch matrix in conjunction with a switch control module, a switchless port mapping circuit (e.g., low speed port mapping circuit 2300), or a combination thereof. The switch matrix may be suitable for all types of signals (e.g., low, medium, and high speed) but the more signals that are supported require additional hardware and connections. Switchless port mapping may be suitable for low speed signals, but not medium or high speed signals, and do not require as much hardware or connections as the switch matrix. Thus, depending on a use case or application, an appropriate mix and match of port mapping solutions can be used in concert to best serve that use case or application.

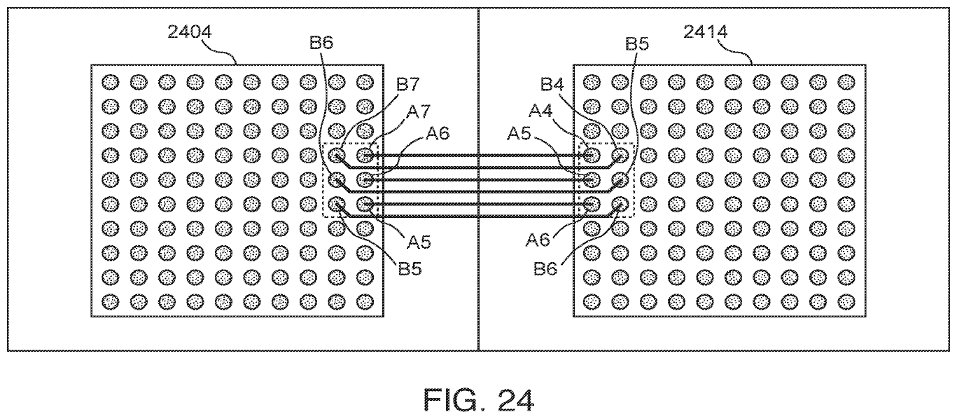

FIG. 24 shows an illustrative example of two VPIO ICs that use port swapping to connect signal traces for a highspeed communication link according to an embodiment. The high-speed link can use six (6) ports, three (3) for transmission, and three (3) for reception. Not shown, the ground connection related to the 6 lines. In one implementation, the 6 lines of ports A5, B5, A6, B6, A7, & B7 of 2404 are controlled impedance lines with a solid ground plane underneath them for a microstrip configuration. Using port mapping in accordance with embodiments discussed herein, ports A7, A6, A5, B7, B6, and B5 of VPIO IC 2404 are mapped to ports A4, A5, A6, B4, B5, and B7, respectively, of VPIO IC 2414. This result is a simple straight-line routing without any crossing, controlled impedance, and minimum trace lengths. Impedance can be controlled because the traces can be routed through the same PCB layer and can have a ground plane position above, below, or above and below that PCB layer. Port swapping may be particularly useful for high-speed lines, but can be used to for other ports, if desired. If swapping was not provided in some orientation configuration of 2414 versus 2404, high speed line crossing, line entanglement, and line lengths could be present which may overly degrade the quality of the signals.

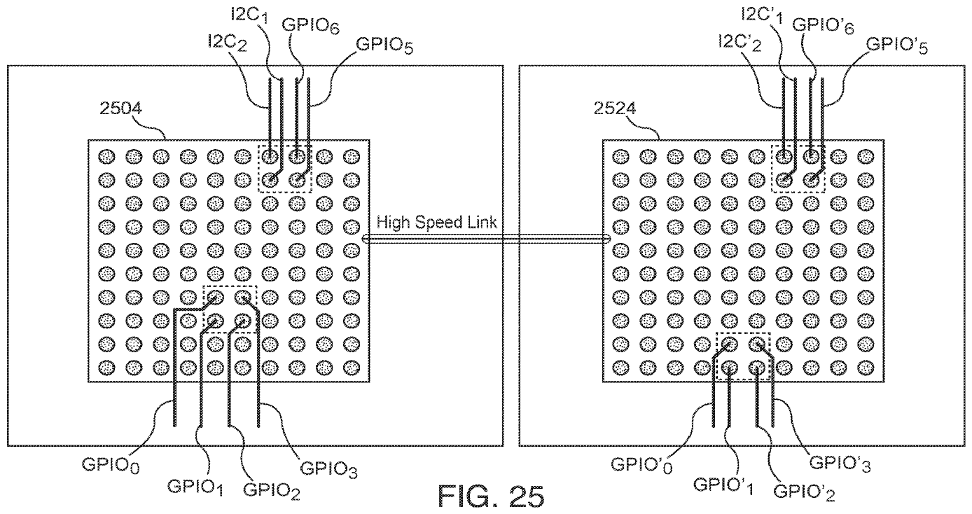

FIG. 25 shows an illustrative example of two VPIO ICs that use groups of port mapping according to an embodiment. Group of port mapping differs to pin mapping in that a group of ports is mapped to another location of the counterpart VPIO solution, not individual ports. Overall, it provides less degrees of freedom per pin location but in many scenarios, input protocol signals are grouped together and want to be mapped together to another location on the counterpart VPIO solution. VPIO IC 2504 shows two different groups of signals, Group 1 including I2C2, I2C1, GPIO5, and GPIO6 being routed to ports D9, D10, C9, and C10, respectively, and Group 2 including GPIO0, GPIO1, GPIO2, and GPIO3 being routed to ports F4, F3, E3, and E4, respectively. A high-speed serial link may connect VPIO IC 2504 and VPIO IC 2524 together. Through application of groups of port mapping, the signals associated with Group 1′ and Group 2′ are routed as shown in VPIO IC 2524. Group 1′ signals of I2C2′, I2C1′, GPIO5′, and GPIO6′are mapped to ports G1, G2, H1, and H2, respectively. Group 2′ signals of GPIO0′, GPIO1′, GPIO2′, and GPIO3′ are mapped to ports E9, E10, F10, and F9, respectively. One can observe that the layout trace outing has been optimized versus a situation where the group of ports are not mapped and happen to be at an opposite direction from where they need to be router. When many or all the input ports are allocated, for instance 22 group of ports versus 25 groups of 4 ports, the routing in 2524 becomes excessively difficult and require multiple layers and create a number of entanglements.

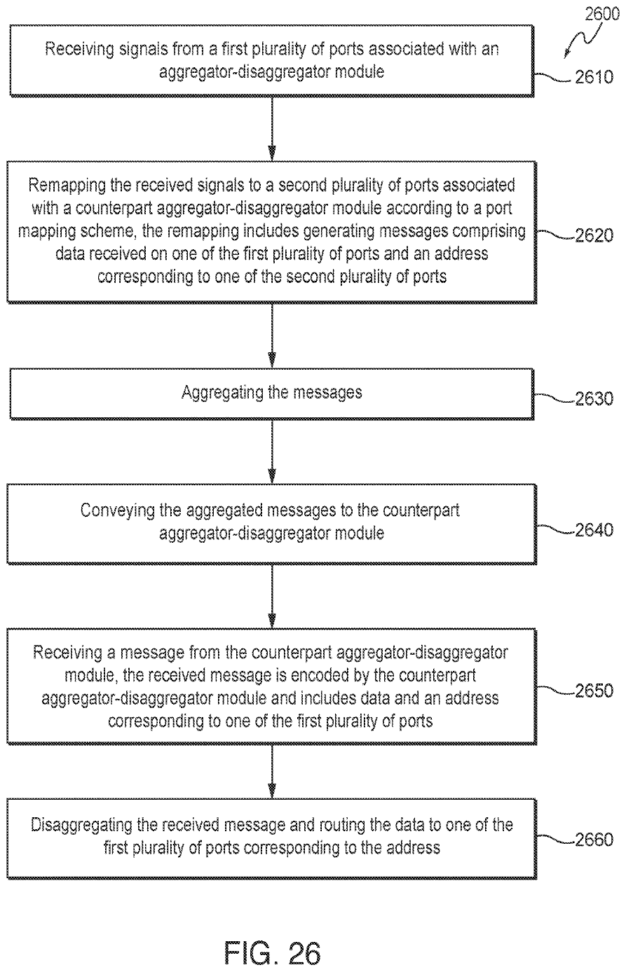

FIG. 26 shows illustrative process 2600 for remapping according to an embodiment. Process 2600 can receive signals from a first plurality of ports associated with an aggregator-disaggregator module, at step 2610. At step 2620, the received signals can be remapped to a second plurality of ports associated with a counterpart aggregator-disaggregator module according to a port mapping scheme. The remapping can generate messages comprising data received on one of the first plurality of ports and an address corresponding to one of the second plurality of ports. The messages can be aggregated at step 2630 and aggregated messages can be conveyed to the counterpart aggregator-disaggregator module at step 2640.

At step 2650, a message can be received from the counterpart aggregator-disaggregator module. The received message is encoded by the counterpart aggregator-disaggregator module and comprises data and an address corresponding to one of the first plurality of ports. At step 2660, the received message can be disaggregated and the data is routed to one of the first plurality of ports corresponding to the address.

It should be appreciated that the steps shown in FIG. 26 are merely illustrative and that additional steps may be added, the order of the steps may be rearranged, or steps may be omitted.

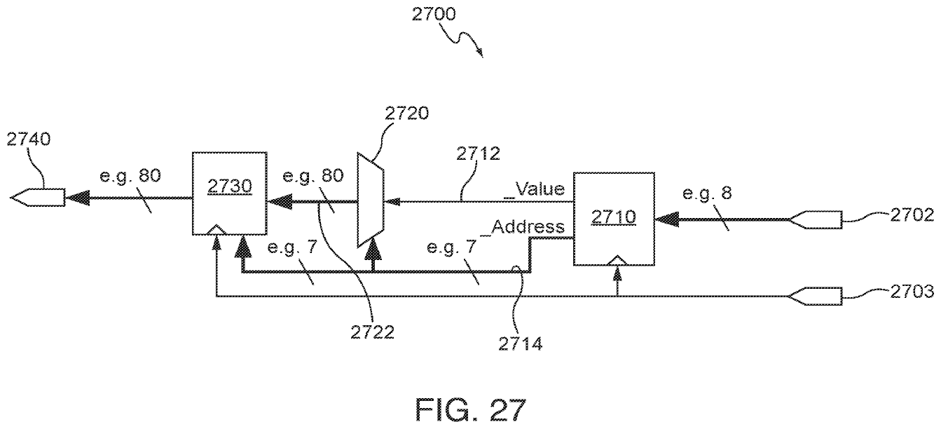

FIG. 27 shows illustrative port recovery circuitry 2700 according to an embodiment. Port recovery circuitry 2700 may be serve as the counterpart to port mapping circuitry 2300 of FIG. 23A. That is, port mapping circuitry 2300 can generate messages (e.g., message 2330) that are conveyed to a counterpart aggregator-disaggregator module or counterpart VPIO circuitry and port recovery circuitry 2700 can receive a message (generated by the counterpart aggregator-disaggregator module or counterpart VPIO circuitry) and determine which port to route the data contained in that received message. In other words, port mapping circuitry 2300 operates on the transmit side and port recovery circuitry 2700 operates on the receive side. In one embodiment, port recovery circuitry 2700 can embody decoder 632 and disaggregator 634 of FIG. 6A. In another embodiment, port recovery circuitry 2700 can embody the disaggregator portion of aggregator-disaggregator module 608 of FIG. 6B. In another embodiment, port recovery circuitry can be placed as a link abstraction module between several signals on the disaggregator 634 and the ports 601; wherein, some ports 601 are directly connected to the disaggregator 634, some ports 601 are connected to disaggregator 634 through bi-directional consolidation circuitry 603, and others are connected to disaggregator 634 through port recovery circuitry 2700, Port recovery circuitry 2700 can include input signals 2702, control signal 2703, decoder 2710, de-multiplexer 2720, registers 2730, and output 2740. Input signals 2702 can be provided by a deserializer (e.g., deserializer 694 of FIG. 6A) or the disaggregator (e.g., disaggregator 634 of FIG. 6A). The control signal 2703 is applied at the data source when data is ready. For deserializer 694, the control signal 2703 is provided when deserializing is complete. For disaggregator 634, the control signal is provided when the specific disaggregated data is available. The control signal 2703 may be, for example, a clock that originates from one or more of: the forwarded clock from the counterpart VPIO solution, the forwarded clock from the counterpart aggregator solution, a reconstructed clock from the incoming data stream, a reconstructed clock from the incoming clock stream, a local oscillator, a clock from the data source when data is ready, an output of deserializing when deserializing is complete, an output of disaggregator when the specific disaggregate data is available, a local oscillator controlled by the incoming data or incoming clock, a CDR, a PLL, a DLL, a ring lock loop, a fast lock loop, etc. input signals 2702 can include a message (e.g., message 2330) that is de-concatenated into two different signals by decoder 2710. These two signals include value 2712 and address 2714. Control signal 2703 can control cadence of messages being processed by decoder 2710 and can ensure that only one message is being processed at a time. If an 8 bit message is provided to decoder 2170, value 2712 may occupy 1 bit and address 2714 may occupy 7 bits.

For each received message, the value 2712 is conveyed to de-multiplexer 2720 with its address 2714 controlling which output of de-multiplexer contains value 2712. Output 2722 is provided to registers 2730, each of which can store a value corresponding to an address for a particular message. Registers 2730 receive address 2714 and control signal 2703 and are operative to output the value to the port corresponding to the address associated with the message on output 2740. Registers 2730 can be loaded sequentially with values and those values can be retained until the next value is loaded. In the embodiment illustrated in FIG. 27, de-multiplexer 2720 may provide 80 outputs to 80 registers 2730. It should be understood that any suitable number of outputs 2722 may be implemented (e.g., 1-80).

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated. In addition, ports and pins may be used interchangeably.

Moreover, any processes described with respect to FIGS. 14A-17 and 26, as well as any other aspects of the invention, may each be implemented by software, but may also be implemented in hardware, firmware, or any combination of software, hardware, and firmware.

They each may also be embodied as machine-or computer-readable code recorded on a machine-or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices. The computer-readable medium can also be distributed over network-coupled computer systems so that the computer readable code is stored and executed in a distributed fashion. For example, the computer-readable medium may be communicated from one electronic subsystem or device to another electronic subsystem or device using any suitable communications protocol. The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module or state machine discussed herein may be provided as a software construct, firmware construct, one or more hardware components, or a combination thereof. For example, any one or more of the state machines or modules may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules or state machines are merely illustrative, and that the number, configuration, functionality, and interconnection of existing modules may be modified or omitted, additional modules may be added, and the interconnection of certain modules may be altered.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Therefore, reference to the details of the preferred embodiments is not intended to limit their scope.

1. An electronic device, comprising:
a first plurality of ports;
an aggregator-disaggregator module coupled to the first plurality of ports and a transceiver, the aggregator-disaggregator module comprising an aggregator and a switch matrix, wherein the switch matrix comprises a plurality of source inputs, a plurality of destination outputs, and a plurality of switches, wherein the plurality of source inputs are coupled to the first plurality of ports and wherein the plurality of destination outputs are coupled to the aggregator; and
port mapping coordinator that configures the switch matrix in accordance with a port mapping scheme by setting the plurality of switches to connect the source inputs to the destination outputs, wherein the switch matrix enables the aggregator to remap signals received on the source inputs to the destination outputs, wherein the destination outputs correspond to a second plurality of ports associated with a counterpart aggregator-disaggregator module;
wherein the remapped signals are conveyed to the counterpart aggregator-disaggregator module via the transceiver.

2. The electronic device of claim 1, wherein the port mapping coordinator comprises a switch control module coupled to the switch matrix and operative to control an ON/OFF state of each of the plurality of switches.

3. The electronic device of claim 2, wherein the switch control module is one-time programmable or dynamically reprogrammable.

4. The electronic device of claim 2, wherein the switch control module comprises:
a plurality of de-multiplexers;
a plurality of latches coupled to the plurality of de-multiplexers; and
a plurality of signal control lines coupled to the plurality of latches and the plurality of switches.

5. The electronic device of claim 2, wherein the switch control module comprises:
an address counter;
a memory lookup table coupled to the address counter;
a diplexer coupled to the memory lookup table;
a plurality of latches coupled to the diplexer; and
a plurality of signal lines coupled to the plurality of latches and the plurality of switches.

6. The electronic device of claim 1, wherein the aggregator-disaggregator module further comprises a disaggregator operative to process the remapped signals received via the transceiver, wherein the disaggregator routes the remapped signals to the second plurality of ports.

7. An electronic device, comprising:
a first plurality of ports;
an aggregator-disaggregator module coupled to the first plurality of ports and a transceiver, the aggregator-disaggregator module comprising an aggregator that remaps the first plurality of ports to a second plurality of ports associated with a counterpart aggregator-disaggregator module in accordance with a port mapping scheme; and
port mapping coordinator that configures a signal routing configuration module in accordance with the port mapping scheme to enable the aggregator to remap signals received on the first plurality of ports for output on the second plurality of ports;
wherein the remapped signals are conveyed to the counterpart aggregator-disaggregator module via the transceiver.

8. The electronic device of claim 7, wherein the signal routing configuration module comprises:
a plurality of multiplexers;
a plurality of multiplexer control lines; and
a plurality of traces coupling the first plurality of ports to each of the plurality of multiplexers;
wherein the plurality of multiplexer control lines specify which of the first plurality of ports are output by which plurality of multiplexers.

9. The electronic device of claim 8, further comprising a plurality of transvers lines coupled the plurality of traces to the first plurality of ports.

10. The electronic device of claim 7, wherein the aggregator-disaggregator module further comprises a disaggregator operative to process the remapped signals, wherein the disaggregator routes the remapped signals to second plurality of ports.

11-13. (canceled)

14. A method, implemented in an electronic device, comprising:
receiving signals from a first plurality of ports associated with an aggregator-disaggregator module;
remapping the received signals to a second plurality of ports associated with a counterpart aggregator-disaggregator module according to a port mapping scheme, the remapping comprising generating messages comprising data received on one of the first plurality of ports and an address corresponding to one of the second plurality of ports;
aggregating the messages; and
conveying the aggregated messages to the counterpart aggregator-disaggregator module.

15. The method of claim 14, further comprising:
receiving a message from the counterpart aggregator-disaggregator module, the received message is encoded by the counterpart aggregator-disaggregator module and comprises data and an address corresponding to one of the first plurality of ports; and
disaggregating the received message and routing the data to one of the first plurality of ports corresponding to the address.

16. The method of claim 14, wherein the remapping comprises:
configuring a port mapping circuit according to the port mapping scheme, wherein the port mapping circuit comprises:
an encoder having an input coupled to receive toggle transitions that exist on the first plurality of ports;
a flip flop coupled to an output of the encoder, the flip flop having a flip flop output;
a look up table coupled the flip flop output, the look up table providing an address to an output bus based on the flip flop output;
a multiplexer coupled to the first plurality of ports, wherein the flip flop output selects a signal existing on one of the first plurality of ports for output on a multiplexer output; and
an inverter coupled to the multiplexer output and the output bus, the inverter providing data to the output bus, wherein the data and the address are concatenated on the output bus as one of the messages provided to the aggregator.

17. The method of claim 14, wherein the remapping comprises remapping a first group of signals selected from the first plurality of ports to a second group of ports selected from the second plurality of ports.

18. The method of claim 14, wherein the remapping comprises remapping a first port selected from the first plurality of ports to a second port selected from the second plurality of ports.

19. The method of claim 14, wherein the remapping comprises remapping a first signal selected from the first plurality of ports to a second port selected from the second plurality of ports.

20-22. (canceled)
